(19) United States
(12) Patent Application Publication
(10) Pub. No.: US 2026/0202612 A1
(43) Pub. Date: Jul. 16, 2026

(54) OPTICAL WAVEGUIDE AND WIRING BOARD

(71) Applicant: IBIDEN CO., LTD., Gifu (JP)

(72) Inventors: Kouhei KAWAI, Gifu (JP); Haruka FURUMACHI, Gifu (JP)

(73) Assignee: IBIDEN CO., LTD., Gifu (JP)

(21) Appl. No.: 19/564,388

(22) Filed: Mar. 12, 2026

Related U.S. Application Data
(63) Continuation-in-part of application No. PCT/JP2024/032356, filed on Sep. 10, 2024.

(30) Foreign Application Priority Data
Sep. 13, 2023 (JP) 2023-148731

(51) Int. Cl. G02B 6/122; G02B 6/125; G02B 6/43

(52) U.S. Cl. CPC G02B 6/1228; G02B 6/125; G02B 6/43

(57) ABSTRACT

An optical waveguide includes an optical waveguide body including a lower cladding, a core and an upper cladding and having an upper cladding non-formation region and an upper cladding formation region. The optical waveguide body has a core exposed portion and a core non-exposed portion formed such that the core exposed portion has an upper surface of the core exposed at at least one end of the optical waveguide body in the upper cladding non-formation region, the core non-exposed portion has the upper surface of the core not exposed in the upper cladding formation region, and the optical waveguide body is formed to satisfy W1>W2, where W1 is a core width of the core exposed portion and W2 is a core width of the core non-exposed portion.

### CROSS-REFERENCE TO RELATED APPLICATIONS

The present application is a continuation of and claims the benefit of priority to International Application No. PCT/JP2024/032356, filed Sep. 10, 2024, which is based upon and claims the benefit of priority to Japanese Application No. 2023-148731, filed Sep. 13, 2023. The entire contents of these applications are incorporated herein by reference.

### BACKGROUND OF THE INVENTION

### Field of the Invention

The present invention relates to an optical waveguide and a wiring board.

### Description of Background Art

Japanese Patent Application Laid-Open Publication No. 2014-81586 describes a polymer waveguide array formed on a polymer film and a silicon waveguide array formed on a silicon chip. The entire contents of this publication are incorporated herein by reference.

### SUMMARY OF THE INVENTION

According to one aspect of the present invention, an optical waveguide includes an optical waveguide body including a lower cladding, a core and an upper cladding and having an upper cladding non-formation region and an upper cladding formation region.

The optical waveguide body has a core exposed portion and a core non-exposed portion formed such that the core exposed portion has an upper surface of the core exposed at at least one end of the optical waveguide body in the upper cladding non-formation region, the core non-exposed portion has the upper surface of the core not exposed in the upper cladding formation region, and the optical waveguide body is formed to satisfy W1>W2, where W1 is a core width of the core exposed portion and W2 is a core width of the core non-exposed portion.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a plan view illustrating an example of an optical waveguide according to an embodiment of the present invention;

FIG. 2A is across-sectional view of the optical waveguide in the example of FIG. 1 along a line (IIA-IIA);

FIG. 2B is a right-side view of the optical waveguide in the example of FIG. 1;

FIG. 2C is a cross-sectional view of the optical waveguide in the example of FIG. 1 along a line (IIC-IIC);

FIG. 2D is a plan view illustrating a first modified example of connecting portions of cores in an optical waveguide according to an embodiment of the present invention;

FIG. 2E is a plan view illustrating a second modified example of connecting portions of cores in an optical waveguide according to an embodiment of the present invention;

FIG. 3 is a cross-sectional view illustrating another example of a cladding in an optical waveguide according to an embodiment of the present invention;

FIG. 4 is a cross-sectional view illustrating a modified example of an optical waveguide according to an embodiment of the present invention;

FIG. 5 is a cross-sectional view illustrating a first modified example of an optical waveguide according to an embodiment of the present invention;

FIG. 6A is a cross-sectional view illustrating a second modified example of an optical waveguide according to an embodiment of the present invention;

FIG. 6B is a cross-sectional view illustrating a third modified example of an optical waveguide according to an embodiment of the present invention;

FIG. 7 is a cross-sectional view illustrating an example of a wiring board according to a first embodiment of the present invention;

FIG. 8 is a cross-sectional view illustrating an application example of the wiring board of FIG. 7;

FIG. 9 is a cross-sectional view illustrating a modified example of the wiring board of the first embodiment together with an optical fiber;

FIG. 9A is an enlarged cross-sectional view illustrating a coupling portion between the optical waveguide and the optical fiber in the example of FIG. 9;

FIG. 10 is a cross-sectional view illustrating a modified example of the wiring board of the first embodiment together with an external optical waveguide;

FIG. 11 is a cross-sectional view illustrating an example of a wiring board according to a second embodiment of the present invention;

FIG. 12 is a cross-sectional view illustrating a modified example of the wiring board of the second embodiment together with an optical fiber;

FIG. 13 is a cross-sectional view illustrating a modified example of the wiring board of the second embodiment together with an external optical waveguide;

FIG. 14A is a front view illustrating an example of a manufacturing process for an optical waveguide according to an embodiment of the present invention;

FIG. 14B is a plan view illustrating an example of a manufacturing process for an optical waveguide according to an embodiment of the present invention;

FIG. 14C is a front view illustrating an example of a manufacturing process for an optical waveguide according to an embodiment of the present invention; and

FIG. 14D is a front view illustrating an example of a manufacturing process for an optical waveguide according to an embodiment of the present invention.

### DETAILED DESCRIPTION OF THE EMBODIMENTS

Embodiments will now be described with reference to the accompanying drawings, wherein like reference numerals designate corresponding or identical elements throughout the various drawings.

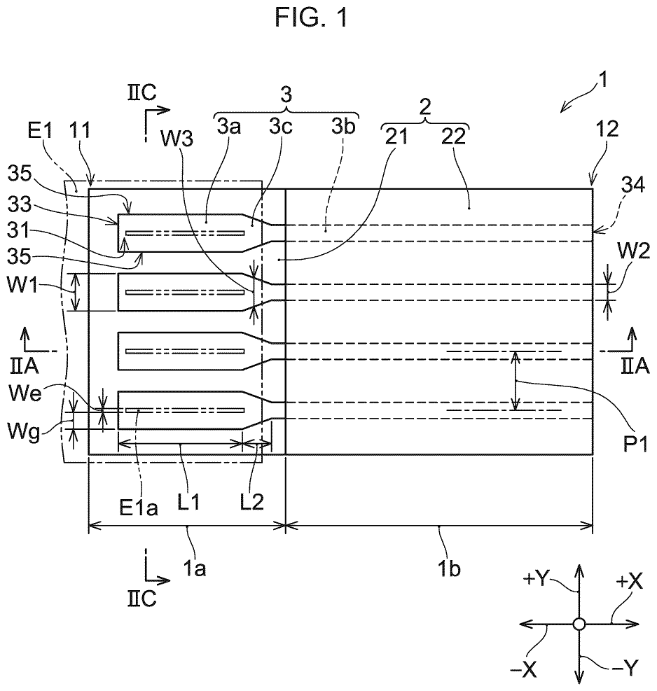

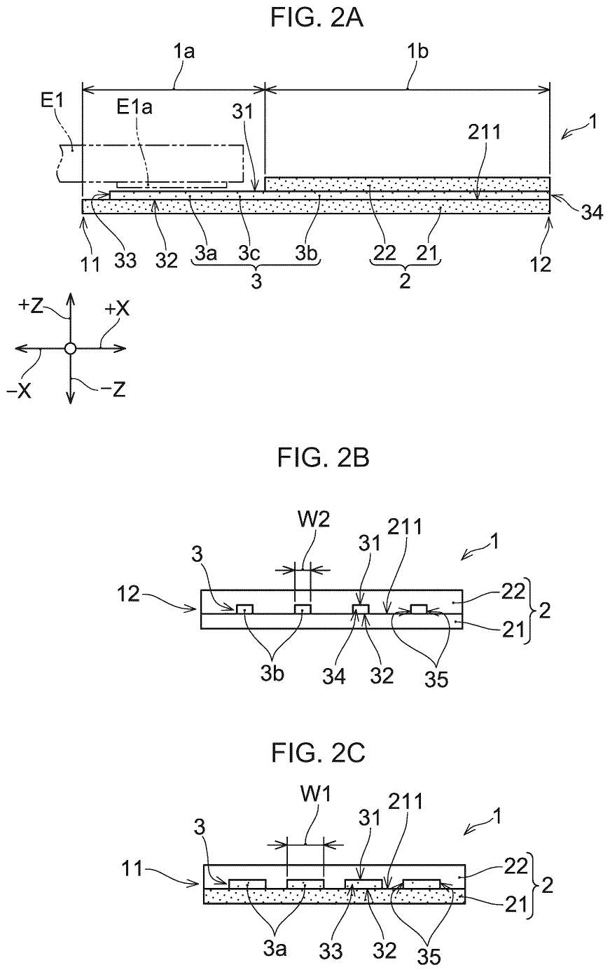

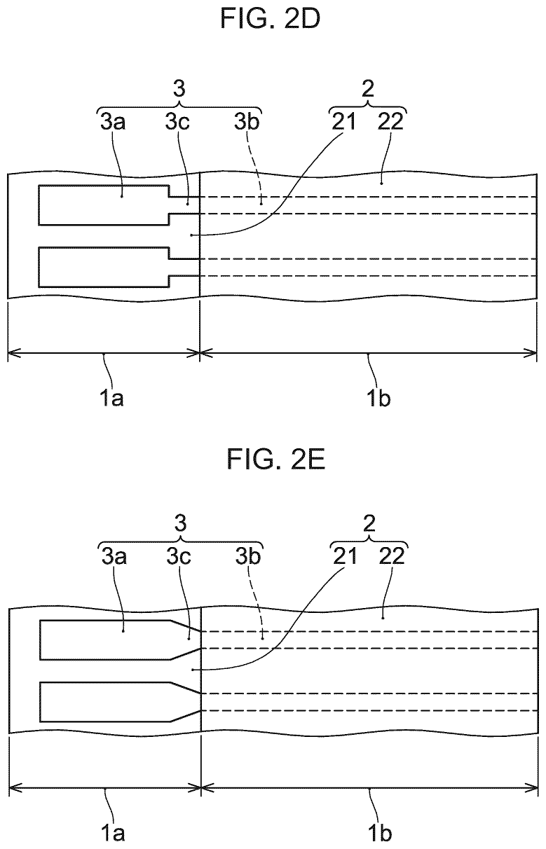

Structure of Optical Waveguide FIG. 1 illustrates a plan view of an optical waveguide 1, which is an example of an optical waveguide according to an embodiment of the present invention. FIG. 2A illustrates a cross-section of the optical waveguide 1 of FIG. 1 along a line (IIA-IIA). FIG. 2B illustrates a right-side view of the optical waveguide 1 of FIG. 1. FIG. 2C illustrates a cross-sectional view along a line (IIC-IIC) in FIG. 1. The optical waveguide 1 exemplified in FIG. 1 and the like is merely one example of the optical waveguide of the present embodiment. A structure of the optical waveguide of the embodiment is not limited to a structure illustrated in the drawings such as FIG. 1.

As illustrated in FIGS. 1 and 2A to 2C, the optical waveguide 1 of the present embodiment includes cores 3 that transmit optical signals, and a cladding 2 that surrounds the cores 3. The cladding 2 is constituted by a lower cladding 21 and an upper cladding 22. The cores 3 are sandwiched between the lower cladding 21 and the upper cladding 22. That is, in the optical waveguide 1, the lower and upper claddings (21, 22) and the cores 3 are laminated in the order of the lower cladding 21, the cores 3, and the upper cladding 22.

The cores 3 each have an upper surface 31 facing in a direction along a lamination direction of the cladding 2 and the cores 3, and a lower surface 32 that is on the opposite side with respect to the upper surface 31. The lamination direction of the cladding 2 and the cores 3 is also referred to as the “Z direction” (see FIG. 2A) hereinafter. The upper surface 31 may be a surface facing either of two directions (+Z and −Z) along the Z direction. In the example of FIG. 2A, the upper surface 31 is a surface of each core 3 facing the +Z direction, and the lower surface 32 is a surface of each core 3 facing the −Z direction. Hereinafter, in the optical waveguide 1, the lower cladding 21 side is also referred to as the “lower side” or simply “lower,” and the upper cladding 22 side is also referred to as the “upper side” or simply “upper.”

The lower cladding 21 is located on the lower surface 32 side of the cores 3 and is in contact with the lower surfaces 32. The upper cladding 22 is located on the upper surface 31 side of the cores 3 and is in contact with the upper surfaces 31. The upper cladding 22 covers the upper surfaces 31 of the cores 3. The upper cladding 22 also covers an upper surface 211 of the lower cladding 21 (a surface facing the upper cladding 22). As illustrated in FIG. 2B, in the optical waveguide 1, the upper cladding 22 also covers side surfaces 35 of each core 3. The side surfaces 35 are surfaces extending along a direction in which the core 3 extends, among surfaces connecting the upper surface 31 and the lower surface 32.

In the optical waveguide 1 of FIGS. 1 and 2A, the cores 3 extend along the +X direction and the −X direction. Optical signal propagating through the cores 3 propagate in the +X direction or the −X direction. In the following, the propagation direction of an optical signal is also simply referred to as the “X direction,” which collectively denotes the +X direction and the −X direction. The optical waveguide 1 has two opposing ends (one end 11 and the other end 12). In the example of FIG. 1, the one end 11 and the other end 12 face each other in the X direction. In the optical waveguide 1, an optical signal enters at the one end 11 or the other end 12, and the optical signal exits from the other end 12 or the one end 11. When an optical signal enters at the one end 11 side, the optical signal exits from the other end 12 side. When an optical signal enters at the other end 12 side, the optical signal exits from the one end 11 side.

In the optical waveguide 1, a portion of each core 3 on a side where an optical signal enters and a portion of each core 3 on a side where an optical signal exits are exposed. In the optical waveguide 1, an optical signal may enter at the one end 11, and an optical signal may also exit from the one end 11. Similarly, an optical signal may enter at the other end 12, and an optical signal may also exit from the other end 12. In the optical waveguide 1, a portion of each core 3 is exposed at both the one end 11 and the other end 12. As illustrated in FIGS. 1, 2A, and 2C, at the one end 11, for each core 3, the upper surface 31, one end surface 33 of the core 3 in the X direction, and the side surfaces 35 are exposed from the cladding 2. At the other end 12, as illustrated in FIGS. 1, 2A, and 2B, an end surface 34, which is the other end surface in the X direction and is on the opposite side with respect to the end surface 33, is exposed from the cladding 2.

As illustrated in FIGS. 1 and 2A, in the optical waveguide 1, the upper cladding 22 covers the upper surface 31 of each core 3 and the upper surface 211 of the lower cladding 21. The optical waveguide 1 is constituted by an upper cladding non-formation region (1a), which is a region where the upper cladding 22 is not formed in plan view, and an upper cladding formation region (1b), which is a region where the upper cladding 22 is formed in plan view. That is, the optical waveguide 1 has the upper cladding non-formation region (1a) and the upper cladding formation region (1b). In plan view, in the upper cladding non-formation region (1a), the upper surface 31 of each core 3 and the upper surface 211 of the lower cladding 21 are exposed. In the example of FIG. 1, in the upper cladding non-formation region (1a), the side surfaces 35 of each core 3 are also exposed. The term “plan view” means viewing an object along the Z direction.

In the optical waveguide 1, in the upper cladding non-formation region (1a), each core 3 has a core exposed portion (3a) where the upper surface 31 of the core 3 is exposed. In the optical waveguide 1, the upper cladding non-formation region (1a) is provided on the one end 11 side. Therefore, as illustrated in FIGS. 1 and 2A, the core exposed portion (3a) is located at the one end 11 of the optical waveguide 1. The core exposed portion (3a) is a portion of each core 3 on the one end 11 side of the optical waveguide 1. In the optical waveguide 1 illustrated in FIG. 1 and the like, the upper cladding formation region (1b) is adjacent to the upper cladding non-formation region (1a), and the upper cladding formation region (1b) is formed on the other end 12 side of the upper cladding non-formation region (1a). The upper cladding formation region (1b) may be formed over the entire other end 12 side of the upper cladding non-formation region (1a).

The core exposed portion (3a) refers to a portion of each core in the upper cladding non-formation region (1a) where the upper surface of the core is exposed and where a width (W1) of the core is greater than a width (W2) of the core in the upper cladding formation region (1b). Further, the core exposed portion (3a) is overlapped with a light-receiving or light-emitting part (E1a) of a component (E1) to perform optical signal coupling. An end part of the core exposed portion (3a) refers to a widest portion of each core 3 along the core exposed portion (3a) extending from a core non-exposed portion (3b) of the core 3. The core exposed portion (3a) may be optically coupled to an external optical connecting component (for example, an optical fiber or an optical waveguide other than the optical waveguide 1).

In the upper cladding formation region (1b), each core 3 has the core non-exposed portion (3b) where the upper surface 31 of the core 3 is not exposed. The core non-exposed portion (3b) is a portion of each core 3 on the other end 12 side of the optical waveguide 1. In the optical waveguide of the embodiment, the upper cladding non-formation region (1a) may be provided at both ends of the optical waveguide. That is, the upper cladding formation region (1b) may be formed between two upper cladding non-formation regions (1a) in the X direction. In the optical waveguide of the embodiment, the upper cladding non-formation region (1a) is provided at at least one end of the optical waveguide (for example, the one end 11 and/or the other end 12 in FIG. 1). Therefore, the core exposed portion (3a) is also located at at least one end of the optical waveguide.

The cores 3 and the cladding 2 constituting the optical waveguide 1 are formed of any light-transmissive material. The optical waveguide 1 can be constituted, for example, by an organic material (organic substance), an inorganic material (inorganic substance), or a hybrid material including both an organic material and an inorganic material, such as an inorganic polymer. Examples of inorganic materials include quartz glass, silicon, and the like, and examples of organic materials include acrylic resins such as polymethyl methacrylate (PMMA), polyimide resins, polyamide resins, polyether resins, silicone resins, phenol resins, epoxy resins, and the like. An optical waveguide 1 formed of an organic material tends to be lightweight and has high toughness. Further, an optical waveguide 1 formed of an organic material tends to have flexibility. Therefore, with an optical waveguide 1 formed of an organic material, the degree of freedom in relative positional formation in the Z direction between an optical component optically coupled at the one end 11 of the optical waveguide 1 and an optical component optically coupled at the other end 12 may be increased.

The cores 3 and the cladding 2 may be formed of mutually different materials or may be formed of materials of the same type. However, for the cores 3, a material having a higher refractive index than the material used for the cladding 2 is employed so that total reflection of an optical signal at an interface between each core 3 and the cladding 2 is possible. The cores 3 and the cladding 2 may be formed of materials having the same refractive index and then subjected to appropriate processing to make their refractive indices different from each other. That is, the optical waveguide 1 may be formed, for example, using a formation method called a photobleaching method. The optical waveguide 1 may be formed on a support that supports the optical waveguide 1 during a manufacturing process and then separated from the support for use, or may be used together with the support.

When the optical waveguide 1 is in use, the cores 3 are optically coupled, at the one end 11 and the other end 12, to optical components such as photoelectric conversion components (such as semiconductor devices including photoelectric conversion elements) and/or connector members that connect to outside of the waveguide (such as optical fibers or optical connectors). That is, the cores 3 are positioned with respect to these optical components so as to have a positional relationship that enables transmission and reception of optical signals between the cores 3 and the optical components. In FIGS. 1 and 2A, the component (E1) provided with a photoelectric conversion element (not illustrated) is indicated by a two-dot chain line, as an example of an optical component that is optically coupled to the cores 3 at the one end 11.

The component (E1) includes the light-receiving or light-emitting part (E1a), which is a portion where an optical signal enters the component (E1) or a portion from which an optical signal exits the component (E1). The component (E1) is optically coupled to the cores 3 at the light-receiving or light-emitting part (E1a). An optical signal that has propagated through the cores 3 from the other end 12 enters the component (E1) from the one end 11 via the light-receiving or light-emitting part (E1a). On the other hand, an optical signal emitted from the light-receiving or light-emitting part (E1a) of the component (E1) enters the cores 3 at the one end 11, propagates through the cores 3, and exits from the other end 12.

In the example of FIGS. 1 and 2A, each core 3 is positioned such that, at the one end 11 of the optical waveguide 1, the upper surface 31 and the light-receiving or light-emitting part (E1a) of the component (E1) face each other to achieve optical coupling (adiabatic coupling). That is, an optical signal that has propagated through a core 3 toward the one end 11 partially leaks out from the upper surface 31 to the outside of the core 3 as evanescent light and enters the light-receiving or light-emitting part (E1a) of the component (E1). Since the upper surface 31 faces the light-receiving or light-emitting part (E1a) of the component (E1) without the cladding 2 interposed therebetween, it is thought that highly efficient optical coupling is achieved.

The optical waveguide 1 illustrated in FIG. 1 and the like has four cores 3 formed in parallel. Without being limited to having four cores, the optical waveguide 1 of the embodiment may have any number of one or more cores 3. For example, the number of cores 3 is in a range of 2 or more and 64 or less. When multiple cores 3 are provided, the cores 3 may have a pitch (P1) of, for example, 10 μm or more and 300 μm or less, and preferably 20 μm or more and 250 μm or less. The pitch (P1) of the multiple cores 3 is not limited to these numerical examples. In the example of FIG. 1, the pitch (P1) of the cores 3 is constant between the one end 11 and the other end 12. The pitch (P1) of the cores 3 may vary between the one end 11 and the other end 12. The pitch (P1) of the cores 3 is a distance between a center of one core 3 and a center of another core 3.

Each core 3 has a width (W1) in the core exposed portion (3a). Each core 3 has a width (W2) in the core non-exposed portion (3b). The core exposed portion (3a) is a portion of each core 3 that is located in the upper cladding non-formation region (1a) and has the width (W1). The core non-exposed portion (3b) is a portion of each core 3 that is located within the upper cladding formation region (1b) and has the width (W2).

The “width” of each core 3, such as the width (W1) or the width (W2), is a length of the core 3 in a direction orthogonal to both the propagation direction of an optical signal propagating through the core 3 (the X direction in FIG. 1) and the lamination direction of the optical waveguide 1 (the Z direction). The direction along the width of each core 3 is also referred to as the +Y direction or the −Y direction (see FIG. 1) hereinafter. The +Y direction and the −Y direction are also collectively referred to simply as the “Y direction.” When a core 3 is curved along its path, the propagation direction of an optical signal in the core 3 is not constant and changes depending on a portion (section) of the core 3. Therefore, the direction along which the width of each core 3 extends may vary between the one end and the other end of the core 3.

In the optical waveguide of the embodiment, the width (W1) of the core exposed portion (3a) and the width (W2) of the core non-exposed portion (3b) satisfy a relationship of the following Formula 1: W1>W2.

That is, the width (W1) of the core exposed portion (3a) and the width (W2) of the core non-exposed portion (3b) are different. The width (W1) of the core exposed portion (3a) is greater than the width (W2) of the core non-exposed portion (3b). In the example of FIG. 1, the width (W1) of the core 3 at the one end 11 of the optical waveguide 1 is greater than the width (W2) of the core 3 at the other end 12. Therefore, a difference between the width (W1) of the core exposed portion (3a) and a width (We) of the light-receiving or light-emitting part (E1a) of the component (E1) is larger than a difference between the width (W2) of the core non-exposed portion (3b) and the width (We) of the light-receiving or light-emitting part (E1a).

Therefore, in the present embodiment, compared to a case where each core 3 has the same width as the width (W2) of the core non-exposed portion (3b) also in the core exposed portion (3a), an allowable range of positional misalignment in the direction along the width of each core 3 when aligning the core 3 with an optical signal entry/exit part of an optical component, such as the light-receiving or light-emitting part (E1a), is greater. That is, when each core 3 and the light-receiving or light-emitting part (E1a) are overlapped as illustrated in FIG. 1 in the core exposed portion (3a), a width (Wg) of a margin portion of the core 3 that does not overlap with the light-receiving or light-emitting part (E1a) in plan view is larger than a width of a margin portion of the core 3 when the core 3 and the light-receiving or light-emitting part (E1a) are overlapped in the core non-exposed portion (3b). Therefore, even when alignment between an optical component such as the component (E1) and each core 3 is slightly misaligned in the direction along the width of the core 3 (the +Y direction or the −Y direction in FIG. 1), it is thought that an optical signal emitted from one of the optical component and the core 3 easily enter the other. That is, even when such positional misalignment occurs, it is thought that substantial optical coupling efficiency between the optical component and the core 3 is easily maintained.

Therefore, in the present embodiment, it is thought that alignment for appropriately optically coupling an optical component such as the component (E1) with each core 3 is facilitated. In particular, it is thought that alignment in the direction along the width of each core 3 is facilitated. Therefore, according to the optical waveguide of the embodiment, it is thought that high coupling efficiency in coupling with an optical component is easily achieved. Further, it is thought that coupling failure due to positional misalignment between each core 3 and an optical component such as the component (E1) caused by thermal history during use is suppressed.

In addition, in the present embodiment, since the core non-exposed portion (3b) has the width (W2) smaller than the width (W1), it is thought that a desired transmission mode is easily realized in the core non-exposed portion (3b). For example, in a light-guiding member such as the optical waveguide 1, a size of a cross section of an optical path such as a core 3 is selected according to a refractive index difference between a constituent material of the core 3 and a constituent material of the cladding 2 surrounding the core 3 serving as the optical path. That is, by realizing a core 3 having a cross section of an appropriate size corresponding to the refractive indices of the materials, an optical signal can be propagated in a desired transmission mode. In this regard, in the present embodiment, each core 3 is not formed over its entire length with the width (W1) of the core exposed portion (3a), which has a large width for high coupling efficiency with an optical component; instead, the core non-exposed portion (3b) has the width (W2) smaller than the width (W1). Therefore, it is thought that optical transmission in a mode that requires a small core cross section is easily realized. For example, optical transmission in a single mode, which requires a core diameter of 1 to 7 μm, may be possible. In this case, the core diameter may refer to either a core width or a core thickness. In plan view, the core non-exposed portion (3b) may have a shape with a constant width. Further, the shape of the core non-exposed portion (3b) may be a tapered shape or a combination of a tapered portion and a constant-width portion.

In this way, according to the present embodiment, in the core exposed portion (3a), optical coupling (particularly adiabatic coupling) with an external optical component such as the component (E1) can be achieved with excellent coupling efficiency. In addition, in portions other than the optical coupling portion with the optical component, an optical signal can be transmitted in a desired transmission mode. For example, an optical signal may be propagated in a high-speed and low-loss transmission mode such as a single mode. That is, according to the optical waveguide of the present embodiment, it is thought that high-efficiency, low-loss, and high-speed optical transmission between two or more optical components that are optically coupled to the optical waveguide.

Dimensions of the parts of the optical waveguide of the present embodiment illustrated in FIG. 1 and the like are exemplified below. The width (W1) of the core exposed portion (3a) and the width (W2) of the core non-exposed portion (3b) are not particularly limited as long as the width (W1) is greater than the width (W2). However, it is desirable that the width (W1) of each core 3 in the core exposed portion (3a) and the width (W2) of the core in the core non-exposed portion (3b) satisfy a relationship of the following Formula 2:1.0< (W1/W2)≤3.0.

That is, the core exposed portion (3a) preferably has a width (W1) that is greater than the width (W2) of the core non-exposed portion (3b) and is 3 times or less the width (W2).

The width (W1) of each core 3 in the core exposed portion (3a) is preferably 3 μm or more and 30 μm or less, and more preferably 5 μm or more and 20 μm or less. When each core 3 has a width in this range in the core exposed portion (3a), it is thought that an effect of facilitating alignment with an optical component such as the component (E1) is obtained, and moreover, an excessively large region for optical coupling with the optical component is not required. The width (W2) of the core non-exposed portion (3b) is preferably, for example, 1 μm or more and 10 μm or less. The width (W1) of the core exposed portion (3a) is a width of a widest portion of each core 3 in the core exposed portion (3a), and the width (W2) of the core non-exposed portion (3b) is a width of a narrowest portion of the core 3 in the core non-exposed portion (3b).

The width of each core 3 is determined as an average of values measured at three points in the X direction. The core width in the core exposed portion (3a) may be constant or may vary. As an example, the core width of the core exposed portion (3a) may gradually increase or decrease from the one end toward the other end. When the width of the core exposed portion (3a) varies, the core width (W1) of the core exposed portion (3a) is determined as an average of values measured at three points in the core exposed portion (3a) in the X direction. The core width of the core non-exposed portion (3b) may be constant or may vary. As an example, the core width of the core non-exposed portion (3b) may gradually increase or decrease from the one end toward the other end. When the width of the core non-exposed portion (3b) varies, the core width (W2) of the core non-exposed portion (3b) is determined as an average of values measured at three points in the core non-exposed portion (3b) in the X direction.

The thickness of each core 3 is determined as an average of values measured at three points in the Z direction. The thickness of each core 3 is not particularly limited, but is 1 μm or more and 20 μm or less, and preferably 3 μm or more and 10 μm or less.

A ratio of the width of each core 3 to the thickness of the core 3 in the core exposed portion (3a) is not particularly limited, but it is preferable that the width of the core 3: the thickness of the core 3=1.0:1.0 to 4.0:1.0. A ratio of the width of each core 3 to the thickness of the core 3 in the core non-exposed portion (3b) is not particularly limited, but it is preferable that the width of the core 3: the thickness of the core 3=0.9:1.0 to 1.4:1.0. A cross-sectional shape of each core 3 in the core non-exposed portion (3b) is square or rectangular.

A length (L1) of each core 3 in the core exposed portion (3a) is preferably 100 μm or more and 3000 μm or less, and more preferably 100 μm or more and 2500 μm or less. When the core exposed portion (3a) has a length in this range, it is thought that the degree of freedom in selecting an optical component to be optically coupled in the core exposed portion (3a) is high, and moreover, a necessary and sufficient allowable range is obtained in alignment with the optical component in a direction orthogonal to the direction along the width of each core 3.

### Lower Cladding

A thickness of the lower cladding 21 is determined as an average of values measured at three points in the Z direction. The thickness of the lower cladding 21 is not particularly limited, but is 5 μm or more and 100 μm or less, and preferably 10 μm or more and 50 μm or less.

### Upper Cladding

A thickness of the upper cladding 22 is determined as an average of values measured at three points in the Z direction. The thickness of the upper cladding 22 is not particularly limited, but is 5 μm or more and 100 μm or less, and preferably 10 μm or more and 50 μm or less.

An example of a combination of the dimensions of the parts of the optical waveguide 1 of the embodiment is as follows. In the core exposed portion (3a), the core width is 10 μm, and the core thickness is 7 μm. In the core non-exposed portion (3b), the core width is 7 μm, and the core thickness is 7 μm. The thickness of the lower cladding is 20 μm, and the thickness of the upper cladding is 25 μm.

The width of each core 3, the thickness of each core 3, and the length of the core exposed portion (3a), as well as the thickness of the lower cladding 21 and the thickness of the upper cladding 22, illustrated above are merely examples, and these dimensions of the parts of each core 3 and the thicknesses of the claddings are not limited to the numerical values illustrated above.

### Connecting Portion

In the optical waveguide 1 illustrated in FIG. 1, each core 3 has a connecting portion (3c) between the core exposed portion (3a) and the core non-exposed portion (3b), which connects the core exposed portion (3a) and the core non-exposed portion (3b). As illustrated in FIG. 1, the connecting portion (3c) refers, in plan view, to a portion of each core 3 formed in the upper cladding non-formation region (1a) between the core exposed portion (3a) and the core non-exposed portion (3b). Here, a shape of the connecting portion (3c) of each core 3 may be a shape having a constant width, a tapered shape that narrows toward the core non-exposed portion (3b), or a combination of a constant-width shape and a tapered shape. That is, the connecting portion (3c) may, in plan view, have a taper, may be formed in a straight line of a constant width, or may be formed in a combination of a straight line of a constant width and a taper. The tapered shape of the connecting portion (3c) of each core 3 may be a shape that sequentially widens linearly (or smoothly) on both sides from the core non-exposed portion (3b) toward the core exposed portion (3a), may be a shape that sequentially widens linearly on only one side, or may be a shape that sequentially widens in a stepwise manner on both sides or on only one side.

A core width (W3) of the connecting portion (3c) is smaller than the core width (W1) of the core exposed portion (3a) and is equal to or greater than the core width (W2) of the core non-exposed portion (3b) located in the upper cladding formation region (1b). That is, the core widths (W1, W2, W3) satisfy a relationship of the following Formula 3.

The core width (W1)>the core width (W3)>the core width (W2) (Formula 3)

It is thought that the core width (W3) of the connecting portion (3c) suppresses unintended leakage of an optical signal traveling from the core exposed portion (3a) toward the core non-exposed portion (3b). That is, in the optical waveguide of the embodiment, since the width (W1) of the core exposed portion (3a) is greater than the width (W2) of the core non-exposed portion (3b), it is thought that the connecting portion (3c) connecting the core exposed portion (3a) and the core non-exposed portion (3b) suppresses unintended leakage of an optical signal traveling from the core exposed portion (3a) toward the core non-exposed portion (3b) by having a tapered shape. The core width (W3) of the connecting portion (3c) is not particularly limited, but is preferably 1 μm to 30 μm.

A taper ratio ((W1−W2)/L2) of the tapered shape of each core 3 is, for example, 1 or more and 2 or less. L2 is a length of the tapered portion of the connecting portion (3c) in the X direction. When the connecting portion (3c) has a taper ratio in this range, leakage of an optical signal from the core 3 may be efficiently suppressed within a limited length. In this case, a formation ratio (R) of the tapered shape in the core 3 is preferably 0.01<R<0.2, and more preferably 0.03<R<0.15. The formation ratio (R) of the tapered shape is a ratio of the length of the tapered portion to a total length of the core 3.

### Planar Shape of Core

A planar shape of each core 3 is described with reference also to FIGS. 2D and 2E. FIGS. 2D and 2E illustrate a first modified example and a second modified example of the connecting portions (3c) of the cores 3 in the optical waveguide of the embodiment. Although two cores 3 are depicted in each of FIGS. 2D and 2E, in both the first modified example and the second modified example, any number of cores 3 (for example, 2 or more and 64 or less) may be formed. In FIGS. 2D and 2E, a structural element that is the same as a structural element illustrated in FIG. 1 is denoted using the same reference numeral symbol as the one used in FIG. 1 or is omitted as appropriate, and repetitive description of the structural element is omitted.

When viewed in combination with the upper cladding 22, the planar shape of each core 3 is a combination of the core exposed portion (3a), the connecting portion (3c), and the core non-exposed portion 3b. However, when viewed as each core 3 alone, in FIG. 1, each core 3 has a portion corresponding to the core exposed portion (3a) having a constant width and a portion corresponding to the core non-exposed portion (3b) having a constant width. Between the core exposed portion (3a) and the core non-exposed portion (3b), the connecting portion (3c) is formed having a shape with a constant width, a tapered shape, or a combination of a constant-width portion and a tapered portion.

That is, the shape of the connecting portion (3c) may include a constant-width portion and a tapered portion as in the example of FIG. 1, or may be a constant-width shape as in the first modified example illustrated in FIG. 2D. Further, the shape of the connecting portion (3c) may be a tapered shape over the entire region between the core exposed portion (3a) and the core non-exposed portion (3b), as in the second modified example illustrated in FIG. 2E.

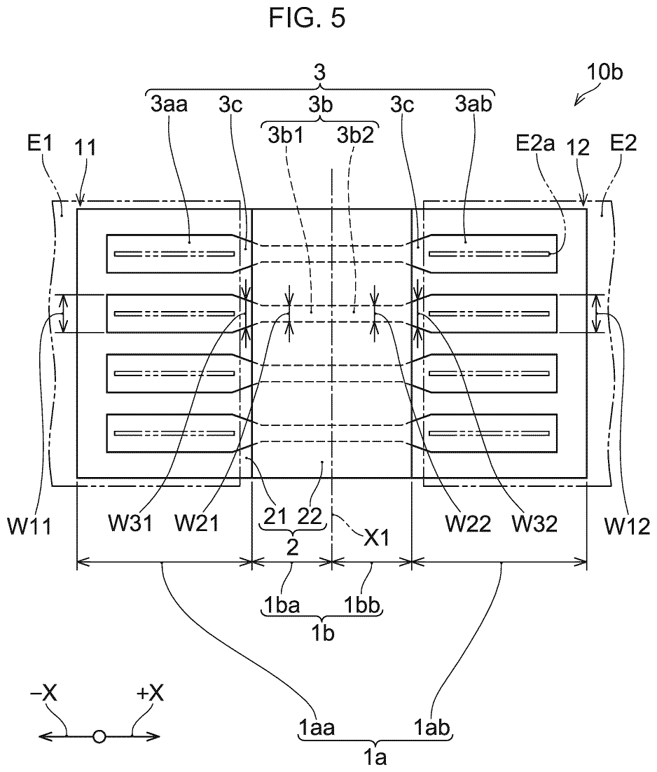

Further, when viewed as each core 3 alone, the shape of each core 3 may include a portion corresponding to the core exposed portion (3a) having a constant width and a portion corresponding to the core non-exposed portion (3b) having a shape that is a combination of a tapered shape and a constant-width shape (see FIGS. 4 and 5). Between the core exposed portion (3a) and the core non-exposed portion (3b), the connecting portion (3c) may be formed having a shape with a constant width, a tapered shape, or a combination of a constant-width portion and a tapered portion. When both the connecting portion (3c) and the core non-exposed portion (3b) have tapered shapes, the shape of each core 3 in plan view may be a tapered shape in which the width continuously changes from the connecting portion (3c) to the core non-exposed portion (3b) (see FIG. 5). Further, when viewed in plan view, the tapered shape of each core 3 may be a shape in which the width changes linearly on both sides (that is, on both the +Y direction side and the −Y direction side with respect to a line passing through a midpoint of the width of the core 3), may be a shape in which the width changes linearly on one side (the +Y direction side or the −Y direction side), or may be a shape in which the width changes stepwise on both sides or on one side.

### Cores Surrounded by Lower Cladding

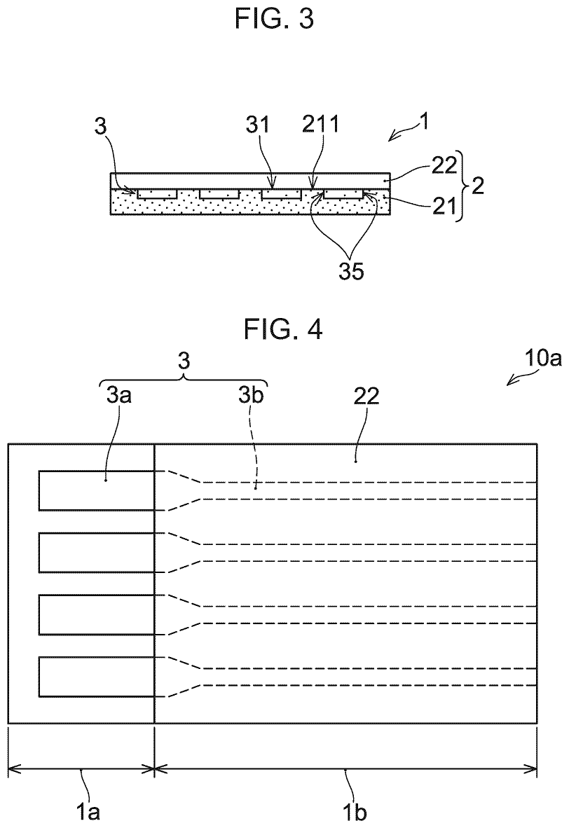

FIG. 3 illustrates another example of the cladding 2 in the optical waveguide 1 of the embodiment. FIG. 3 illustrates a cross section of the example in FIG. 3 taken along a cutting line corresponding to a line (IIC-IIC) illustrated in FIG. 1. In the example illustrated in FIG. 3, each core 3 is surrounded by the lower cladding 21. Therefore, the side surfaces 35 of each core 3 are covered by the lower cladding 21. Therefore, the side surfaces 35 of each core 3 are covered by the cladding 2 not only in the upper cladding formation region (1b) (see FIG. 1) but also in the upper cladding non-formation region (1a) (see FIG. 1). Specifically, the side surfaces 35 are covered by the lower cladding 21. Therefore, it is thought that a transmission mode of an optical signal is less likely to be disturbed in the upper cladding non-formation region (1a).

On the other hand, the upper surface 31 of each core 3 is substantially flush with the upper surface 211 of the lower cladding 21. Therefore, unintended contact between each core 3 and an optical component optically coupled to the core 3 may be avoided. Further, formation of the cores 3 using the photobleaching method may be facilitated.

### Modified Examples of Optical Waveguide

FIG. 4 illustrates an optical waveguide (10a), which is a modified example of the optical waveguide of the embodiment. In the optical waveguide (10a), the core exposed portion (3a) is formed in the upper cladding non-formation region (1a), and the core non-exposed portion (3b) in the upper cladding formation region (1b) has a shape that is a combination of a tapered shape and a constant-width shape. In this way, when the tapered shape of the core non-exposed portion (3b) is covered by the upper cladding 22, it is thought that there is less disturbance in a transmission mode of an optical signal in a core 3.

FIG. 5 illustrates an optical waveguide (10b), which is a first modified example of the optical waveguide of the embodiment. As illustrated in FIG. 5, the optical waveguide (10b) has upper cladding non-formation regions at both the one end 11 and the other end 12 of the optical waveguide (10b). There is a first upper cladding non-formation region (1aa) at the one end 11 of the optical waveguide (10b), and a second upper cladding non-formation region (1ab) at the other end 12 of the optical waveguide (10b). Therefore, in the optical waveguide (10b), the first upper cladding non-formation region (1aa), the upper cladding formation region (1b), and the second upper cladding non-formation region (1ab) are formed in this order. Each core 3 has a first core exposed portion (3aa) and a connecting portion (3c) having a tapered shape in the first upper cladding non-formation region (1aa), and a second core exposed portion (3ab) and a connecting portion (3c) having a tapered shape in the second upper cladding non-formation region (1ab). In the upper cladding formation region (1b), the core non-exposed portion (3b) has a shape that is a combination of two tapered portions and a constant-width portion.

When an imaginary line (X1) is provided at the middle of the upper cladding formation region (1b) in the X direction, a region on the first upper cladding non-formation region (1aa) side of the imaginary line (X1) in the upper cladding formation region (1b) becomes an upper cladding formation region (1ba), and a region on the second upper cladding non-formation region (1ab) side of the imaginary line (X1) becomes an upper cladding formation region (1bb). The imaginary line (X1) is not formed in the optical waveguide (10b) but is provided for convenience in describing the embodiment. Each core 3 has core exposed portions at both one end and the other end of the core 3. Each core 3 has the first core exposed portion (3aa) in the first upper cladding non-formation region (1aa) and the second core exposed portion (3ab) in the second upper cladding non-formation region (1ab). The first core exposed portion (3aa) has a width (W11), and the second core exposed portion (3ab) has a width (W12). Each core 3 has a core non-exposed portion (3b1) in the upper cladding formation region (1ba), and a core non-exposed portion (3b2) in the upper cladding formation region (1bb). The core non-exposed portion (3b1) has a width (W21), and the core non-exposed portion (3b2) has a width (W22). The widths (W11, W12, W21, W22) of each core 3 satisfy relationships of the following Formulas 4 and 5.

$$W 11 > W 21 \qquad ( Formula 4 )$$

$$W 12 > W 22 \qquad ( Formula 5 )$$

That is, the width (W11) of the first core exposed portion (3aa) and the width (W21) of the core non-exposed portion (3b1) are different. The width (W11) of the first core exposed portion (3aa) is greater than the width (W21) of the core non-exposed portion (3b1). The width (W12) of the second core exposed portion (3ab) and the width (W22) of the core non-exposed portion (3b2) are different. The width (W12) of the second core exposed portion (3ab) is greater than the width (W22) of the core non-exposed portion (3b2).

The optical waveguide (10b) of FIG. 5 is optically coupled to the component (E1) and a component (E2). As the component (E2), similarly to the component (E1), a semiconductor device including a photoelectric conversion element is exemplified. A light-receiving or light-emitting part (E2a) of the component (E2) is coupled to the second core exposed portion (3ab). In the optical waveguide (10b), each core 3 has a core exposed portion (the first core exposed portion (3aa)) at the one end 11 of the optical waveguide (10b) and a core exposed portion (the second core exposed portion (3ab)) at the other end 12 of the optical waveguide (10b). Therefore, at the two ends, the cores 3 and optical components such as the component (E1) and the component (E2) can be coupled with good efficiency using a coupling method that uses evanescent light, such as adiabatic coupling. In addition to being optically coupled to the component (E1) and the component (E2), the optical waveguide (10b) of FIG. 5 may be optically coupled to, instead of the component (E2), an external optical connection component such as an optical fiber or another optical waveguide with an exposed core.

Further, since the width (W12) of the second core exposed portion (3ab) is greater than the width (W22) of the core non-exposed portion (3b2), it is thought that alignment for appropriately optically coupling each core 3 with an optical component such as the component (E2) is also easy in the second core exposed portion (3ab). Therefore, it is thought that high coupling efficiency can be easily achieved in coupling with the optical component (E1) and coupling with the optical component (E2). On the other hand, in portions other than the optical coupling portions with the optical components, an optical signal may be transmitted, for example, in a desired transmission mode such as a single mode. That is, according to the optical waveguide (10b) illustrated in FIG. 5, it is thought that high-efficiency, low-loss, and high-speed optical transmission can be provided between two optical components, such as semiconductor devices including photoelectric conversion elements, that are optically coupled to the optical waveguide (10b).

Dimensions of the parts of the optical waveguide (10b) illustrated in FIG. 5 are exemplified below. The width (W11) of the first core exposed portion (3aa) and the width (W21) of the core non-exposed portion (3b1) are not particularly limited as long as the width (W11) is greater than the width (W21). However, it is desirable that, for each core 3, the width (W11) of the first core exposed portion (3aa) and the width (W21) of the core non-exposed portion (3b1) satisfy a relationship of the following Formula 6.

$$1. < ( W 11 / W 21 ) \leq 3. \qquad ( Formula 6 )$$

That is, the first core exposed portion (3aa) preferably has a width (W11) that is greater than the width (W21) of the core non-exposed portion (3b1) and is 3 times or less the width (W21).

The width (W12) of the second core exposed portion (3ab) and the width (W22) of the core non-exposed portion (3b2) are not particularly limited as long as the width (W12) is greater than the width (W22). However, it is desirable that, for each core 3, the width (W12) of the second core exposed portion (3ab) and the width (W22) of the core non-exposed portion (3b2) satisfy a relationship of the following Formula 7.

$$1. < ( W 12 / W 22 ) \leq 3. \qquad ( Formula 7 )$$

That is, the second core exposed portion (3ab) preferably has a width (W12) that is greater than the width (W22) of the core non-exposed portion (3b2) and is 3 times or less the width (W22).

The core width (W11) of the first core exposed portion (3aa) and the core width (W12) of the second core exposed portion (3ab) are preferably 3 μm or more and 30 μm or less, and more preferably 5 μm or more and 20 μm or less. When each core 3 has a width in this range in the first core exposed portion (3aa) and the second core exposed portion (3ab), it is thought that an effect of facilitating alignment with optical components such as the component (E1) and the component (E2) is obtained, and moreover, an excessively large region for optical coupling with the optical components is not required. The width (W21) of the core non-exposed portion (3b1) and the width (W22) of the core non-exposed portion (3b2) are preferably, for example, 1 μm or more and 10 μm or less. The width (W11) of the first core exposed portion (3aa) is a width of a widest portion of each core 3 in the first core exposed portion (3aa), and the width (W12) of the second core exposed portion (3ab) is a width of a widest portion of the core 3 in the second core exposed portion (3ab). The width (W21) of the core non-exposed portion (3b1) is a width of a narrowest portion of each core 3 in the core non-exposed portion (3b1), and the width (W22) of the core non-exposed portion (3b2) is a width of a narrowest portion of the core 3 in the core non-exposed portion (3b2).

In the optical waveguide (10b) illustrated in FIG. 5, each core 3 has a tapered shape in the connecting portions (3c) that narrows toward the core non-exposed portion (3b1) or the core non-exposed portion (3b2). The tapered shape of each core 3 in the connecting portions (3c) may be a shape that sequentially widens linearly on both sides from the core non-exposed portion (3b1) toward the first core exposed portion (3aa) or from the core non-exposed portion (3b2) toward the second core exposed portion (3ab), may be a shape that sequentially widens linearly on only one side, or may be a shape that sequentially widens stepwise on both sides or on only one side.

A core width (W31) of the connecting portion (3c) on the first upper cladding non-formation region (1aa) side is smaller than the core width (W11) of the first core exposed portion (3aa) and is equal to or greater than the core width (W21) of the core non-exposed portion (3b1). That is, a relationship of the core width (W11)>the core width (W31)>the core width (W21) holds. It is thought that the core width (W31) of the connecting portion (3c) suppresses unintended leakage of an optical signal traveling from the first core exposed portion (3aa) toward the core non-exposed portion (3b1). A core width (W32) of the connecting portion (3c) on the second upper cladding non-formation region (1ab) side is smaller than the core width (W12) of the second core exposed portion (3ab) and is equal to or greater than the core width (W22) of the core non-exposed portion (3b2). That is, a relationship of the core width (W12)>the core width (W32)>the core width (W22) holds. It is thought that the core width (W32) of the connecting portion (3c) suppresses unintended leakage of an optical signal traveling from the second core exposed portion (3ab) toward the core non-exposed portion (3b2). The core widths (W31, W32) of the connecting portions (3c) are not particularly limited, but are preferably 1 μm to 30 μm.

In the optical waveguide (10b) illustrated in FIG. 5, when viewed as each core 3 alone, the shape of each core 3 includes a portion corresponding to the first core exposed portion (3aa) having a constant width, a portion corresponding to the second core exposed portion (3ab) having a constant width, and portions corresponding to the core non-exposed portions (3b1, 3b2) that each have a shape that is a combination of a tapered shape and a constant-width shape. The connecting portions (3c) each having a tapered shape are respectively formed between the first core exposed portion (3aa) and the core non-exposed portion (3b1) and between the second core exposed portion (3ab) and the core non-exposed portion (3b2). The shape of each core 3 in plan view has a tapered shape in which the width continuously changes from the connecting portion (3c) to the core non-exposed portion (3b1) in the first upper cladding non-formation region (1aa), and also has a tapered shape in which the width continuously changes from the connecting portion (3c) to the core non-exposed portion (3b2) in the second upper cladding non-formation region (1ab).

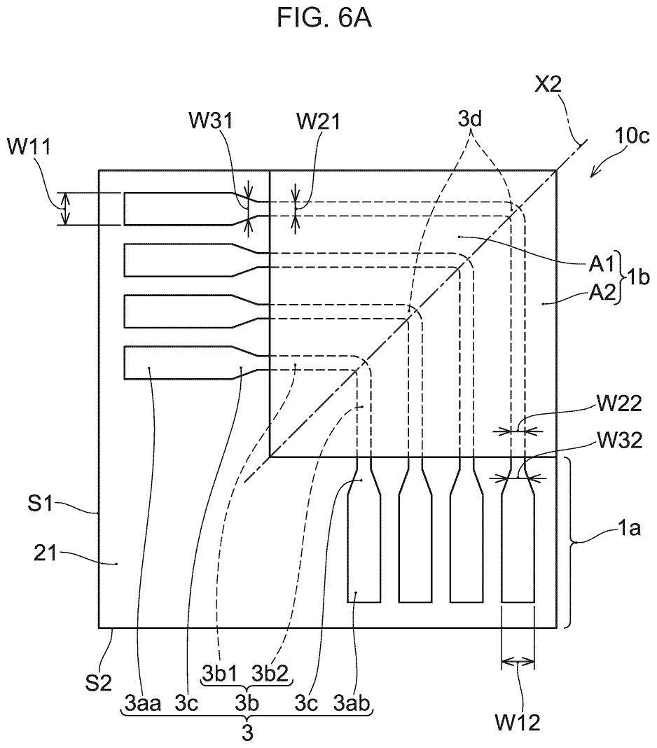

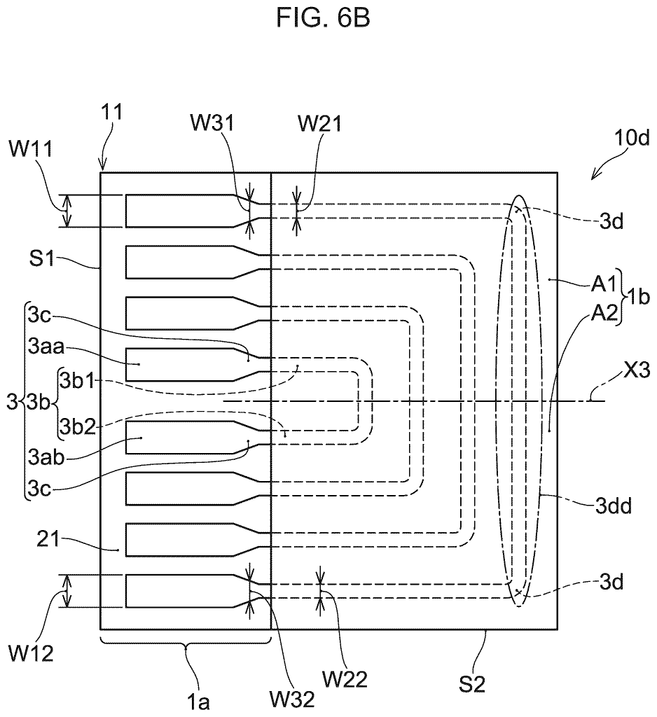

FIGS. 6A and 6B illustrate modified examples of the optical waveguide of the embodiment. FIG. 6A illustrates an optical waveguide (10c) of a second modified example, and FIG. 6B illustrates an optical waveguide (10d) of a third modified example. In both the optical waveguide (10c) and the optical waveguide (10d), similar to the optical waveguide (10b) of FIG. 5, each core 3 has a first core exposed portion (3aa) at one end and a second core exposed portion (3ab) at the other end. A width of the first core exposed portion (3aa) is greater than a width of a core non-exposed portion (3b1). A width of the second core exposed portion (3ab) is greater than a width of a core non-exposed portion (3b2). Therefore, in both the optical waveguide (10c) and the optical waveguide (10d), it is thought that alignment between the component (E1) (see FIG. 5) and the first core exposed portion (3aa) is facilitated, alignment between the component (E2) (see FIG. 5) and the second core exposed portion (3ab) is facilitated, and in portions other than the optical coupling portions with the component (E1) or the component (E2), optical transmission in a desired transmission mode, such as a single mode, can be easily realized.

In the optical waveguide (10c) illustrated in FIG. 6A, each core 3 has an L-shape in plan view. That is, each core 3 has one bent portion (3d) and is bent at an angle of substantially 90° at the bent portion (3d). The angle of the bent portion (3d) can be in a range of 45° to 135°. Optical components to be optically coupled to the optical waveguide (10c) can be freely positioned, and the optical waveguide can be designed accordingly. The bent portion (3d) may be straight or curved, but is preferably curved. When the bent portion (3d) is curved, transmission of an optical signal near the bent portion (3d) is facilitated.

The optical waveguide (10c) is formed in a shape having a side (S 1) of the optical waveguide (10c) that is rectangular in plan view, and a side (S2) substantially orthogonal to the side (S1). The lower cladding 21 is formed in a shape having the side (S1) and the side (S2). The upper cladding non-formation region (1a) is formed in a shape extending along the side (S1) and the side (S2). When an imaginary line (X2) is provided along the bent portions (3d) of the cores 3 in the upper cladding formation region (1b), the upper cladding formation region (1b) is divided by the imaginary line (X2) into an A1 region and an A2 region. The A1 region is a region where the core non-exposed portion (3b) of each core 3 is formed along the side (S2) (that is, substantially parallel to the side (S2)), and the A2 region is a region where the core non-exposed portion (3b) of each core 3 is formed along the side (S1) (that is, substantially parallel to the side (S1)). The imaginary line (X2) is not formed in the optical waveguide (10c) but is provided for convenience in describing the embodiment.

In FIG. 6A, the first core exposed portion (3aa) at one end of each core 3 is formed outside the A1 region. The second core exposed portion (3ab) at the other end of each core 3 is formed outside the A2 region. Along the side (S1), four first core exposed portions (3aa) at the one ends of the cores 3 are formed. Along the side (S2), four second core exposed portions (3ab) at the other ends of the cores 3 are formed. As illustrated in FIG. 6A, since each core 3 has an L-shape, the component (E1) (see FIG. 5) can be positioned in the A1 region and a region of the side (S1), and the component (E2) (see FIG. 5) can be positioned in the A2 region and a region of the side (S2). It is thought that alignment between the component (E1) and the first core exposed portion (3aa) is facilitated. It is thought that alignment between the component (E2) and the second core exposed portion (3ab) is facilitated. In addition, even when the component (E1) and the component (E2) are exposed to thermal history during use after being mounted, since coupling failure due to positional misalignment is suppressed, it is thought that optical coupling with good coupling efficiency can be achieved. Further, it is thought that a desired transmission mode is easily realized.

Each core 3 has the first core exposed portion (3aa) outside the A1 region and the second core exposed portion (3ab) outside the A2 region. The first core exposed portion (3aa) has a width (W11), and the second core exposed portion (3ab) has a width (W12). Each core 3 has a non-exposed core portion (3b1) in the A1 region of the upper cladding formation region (1b), and a non-exposed core portion (3b2) in the A2 region of the upper cladding formation region (1b). The core non-exposed portion (3b1) has a width (W21), and the core non-exposed portion (3b2) has a width (W22). The widths (W11, W12, W21, W22) of each core 3 satisfy relationships of the following Formulas 8 and 9.

$$W 11 > W 21 \qquad ( Formula 8 )$$

$$W 12 > W 22 \qquad ( Formula 9 )$$

That is, the width (W11) of the first core exposed portion (3aa) and the width (W21) of the core non-exposed portion (3b1) are different. The width (W11) of the first core exposed portion (3aa) is greater than the width (W21) of the core non-exposed portion (3b1). The width (W12) of the second core exposed portion (3ab) and the width (W22) of the core non-exposed portion (3b2) are different. The width (W12) of the second core exposed portion (3ab) is greater than the width (W22) of the core non-exposed portion (3b2).

In the optical waveguide (10d) illustrated in FIG. 6B, each core 3 has a U-shape as a whole in plan view. That is, each core 3 has a folded portion (3dd), the folded portion (3dd) has two bent portions (3d), and each core 3 is bent at an angle of substantially 90° at each bent portion (3d). The folded portion (3dd) may be formed by a curve, a combination of straight lines, or a combination of a curve and a straight line. The folded portion (3dd) is preferably curved; when the folded portion (3dd) is curved, transmission of an optical signal near the folded portion (3dd) is facilitated. The optical waveguide (10d) has an upper cladding non-formation region (1a) extending along a side (S1) of the rectangular optical waveguide (10d) in plan view. That is, in the optical waveguide (10d), each core 3 has a first core exposed portion (3aa) at one end and a second core exposed portion (3ab) at the other end. However, the upper cladding non-formation region (1a) is provided only in a region near the one end 11 of the optical waveguide (10d) (a region along the side (S1) in FIG. 6B).

The optical waveguide (10d) is formed in a shape having, in plan view, the side (S1) of the rectangular optical waveguide (10d) and a side (S2) substantially orthogonal to the side (S1). The lower cladding 21 is formed in a shape having the side (S1) and the side (S2). The upper cladding formation region (1b) is divided into an A1 region and an A2 region by an imaginary line (X3) passing through the middle of the folded portions (3dd) of each core 3. The A1 region is a region where the core non-exposed portion (3b) of each core 3 is formed in an upper half (the half on the first core exposed portion (3aa) side) of the upper cladding formation region (1b), and the A2 region is a region where the core non-exposed portion (3b) of each is formed in a lower half (the half on the second core exposed portion (3ab) side) of the upper cladding formation region (1b). The imaginary line (X3) is not formed in the optical waveguide (10d) but is provided for convenience in describing the embodiment.

In FIG. 6B, the first core exposed portion (3aa) at one end of each core 3 is formed outside the A1 region. The second core exposed portion (3ab) at the other end of each core 3 is formed outside the A2 region. Outside the A1 region, four first core exposed portions (3aa) at the one ends of the cores 3 are formed along the side (S1). Outside the A2 region, four second core exposed portions (3ab) at the other ends of the cores 3 are formed along the side (S1). As illustrated in FIG. 6B, since each core 3 has a U-shape, the component (E1) (see FIG. 5) can be positioned outside the A1 region, and the component (E2) (see FIG. 5) can be positioned outside the A2 region. It is thought that alignment between the component (E1) and the first core exposed portion (3aa) is facilitated. It is thought that alignment between the component (E2) and the second core exposed portion (3ab) is facilitated. In addition, even when the component (E1) and the component (E2) are exposed to thermal history during use after being mounted, since coupling failure due to positional misalignment is suppressed, it is thought that optical coupling with good coupling efficiency can be achieved. Further, it is thought that a desired transmission mode is easily realized.

Each core 3 has the first core exposed portion (3aa) outside the A1 region (on the side (S1) side) and the second core exposed portion (3ab) outside the A2 region (on the side (S1) side). The first core exposed portion (3aa) has a width (W11), and the second core exposed portion (3ab) has a width (W12). Each core 3 has a non-exposed core portion (3b1) in the A1 region of the upper cladding formation region (1b), and a non-exposed core portion (3b2) in the A2 region of the upper cladding formation region (1b). The core non-exposed portion (3b1) has a width (W21), and the core non-exposed portion (3b2) has a width (W22). The widths (W11, W12, W21, W22) of each core 3 satisfy relationships of the following Formulas 10 and 11.

$$W 11 > W 21 \qquad ( Formula 10 )$$

$$W 12 > W 22 \qquad ( Formula 11 )$$

That is, the width (W11) of the first core exposed portion (3aa) and the width (W21) of the core non-exposed portion (3b1) are different. The width (W11) of the first core exposed portion (3aa) is greater than the width (W21) of the core non-exposed portion (3b1). The width (W12) of the second core exposed portion (3ab) and the width (W22) of the core non-exposed portion (3b2) are different. The width (W12) of the second core exposed portion (3ab) is greater than the width (W22) of the core non-exposed portion (3b2).

In the optical waveguide (10c) and the optical waveguide (10d), each core 3 has one or two bent portions (3d) that bend at substantially 90 degrees. However, in the optical waveguide of the embodiment, each core 3 may have any number of bent portions that bend at any angle. Further, each core 3 may be rounded at the bent portions. That is, in the optical waveguide of the embodiment, each core 3 is not limited to a linear shape (I-shape) as in FIG. 1 or an L-shape or a U-shape as in FIG. 6A and FIG. 6B, but may have any shape in plan view.

### Structure of Wiring Board

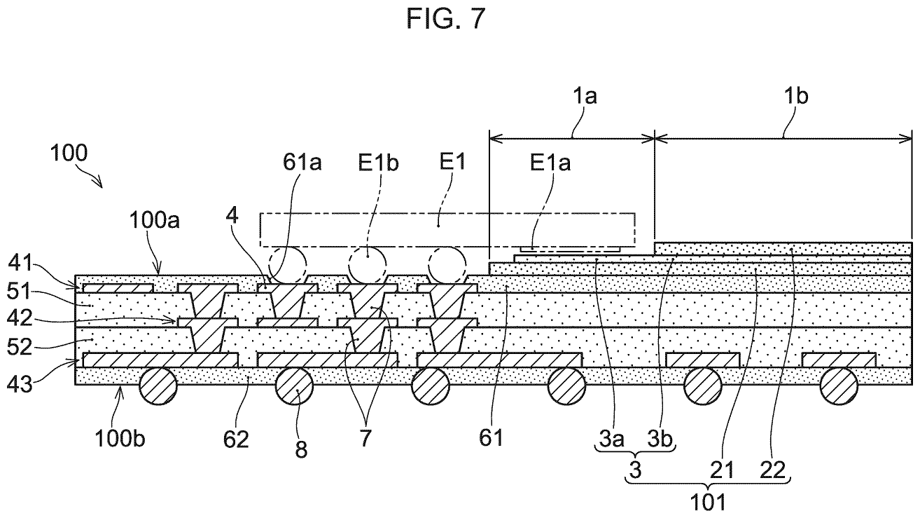

Next, a wiring board according to a first embodiment is described with reference to the drawings. FIG. 7 illustrates a cross-sectional view of a wiring board 100, which is an example of the wiring board of the first embodiment. The wiring board 100 illustrated in FIG. 7 is merely an example of the wiring board of the present embodiment. A laminated structure, and the number of conductor layers and the number of insulating layers, of the wiring board of the embodiment are not limited to the laminated structure of the wiring board 100 of FIG. 7 and the number of conductor layers and the number of insulating layers included in the wiring board 100. Further, the wiring board is also not limited in material.

As illustrated in FIG. 7, the wiring board 100 is a wiring board constituted by conductor layers and insulating layers, and includes conductor layers (41 to 43) as the conductor layers and insulating layers (51, 52) as the insulating layers. The wiring board 100 includes an optical waveguide 101 and component mounting pads 4. The wiring board 100 has a first surface (100a), which is a mounting surface for a component (E1), and a second surface (100b), which is on the opposite side with respect to the first surface (100a). The optical waveguide 101 is formed on a surface (the first surface (100a)) of the wiring board 100.

The conductor layers (41 to 43) and the insulating layers (51, 52) are laminated in the order of the conductor layer 43, the insulating layer 52, the conductor layer 42, the insulating layer 51, and the conductor layer 41 from the second surface (100b) side toward the first surface (100a) side of the wiring board 100. The conductor layer 41 and the conductor layer 42 are connected by via conductors 7 penetrating the insulating layer 51.

The conductor layer 42 and the conductor layer 43 are connected by via conductors 7 penetrating the insulating layer 52. The wiring board 100 includes a solder resist 62 covering the conductor layer 43 and the insulating layer 52, and a solder resist 61 covering the conductor layer 41 and the insulating layer 51. The wiring board 100 also includes bumps 8 connected to conductor pads of the conductor layer 43 and protruding from the solder resist 62. The bumps 8 are made of a conductive material such as solder and are used for electrical and mechanical connection between the wiring board 100 and an external component located on the second surface (100b) side. The wiring board 100 may be used as a motherboard without the bumps 8.

The insulating layers (51, 52) may be formed, for example, using a thermosetting insulating resin such as an epoxy resin, a bismaleimide triazine resin (BT resin), or a phenol resin. The insulating layers (51, 52) may also be formed using a thermoplastic insulating resin such as a fluororesin, a liquid crystal polymer (LCP), a polytetrafluoroethylene (PTFE) resin, a polyester (PE) resin, or a modified polyimide (MPI) resin. The resins listed as materials for the insulating layers are merely examples of materials for forming the insulating layers. The insulating layers may be formed of any material that provides insulation between the conductor layers in the wiring board 100. Although not illustrated, each insulating layer may contain a core material (reinforcing material) made of glass fiber, aramid fiber, or the like, and may also contain an inorganic filler composed of fine particles of silica (SiO₂), alumina, mullite, or the like.

The solder resists (61, 62) are formed of, for example, a photosensitive epoxy resin or polyimide resin, or the like.

The conductor layers (41 to 43) and the via conductors 7 may be formed using any metal having appropriate conductivity, such as copper or nickel. In FIG. 7, these conductors are simplified and depicted as each having a one-layer structure. However, these conductors can each have a multilayer structure including two or more films. For example, the conductor layers (41 to 43) and the via conductors 7 may each have a two-layer structure including an electroless plating film and an electrolytic plating film.

The component mounting pads 4 are conductor pads formed in the conductor layer 41. The solder resist 61 is provided with openings (61a), and the component mounting pads 4 are exposed in the openings (61a). The optical waveguide 101 is formed on the solder resist 61. Although not illustrated, the optical waveguide 101 is fixed to the surface of the wiring board 100 with any fixing member such as an adhesive.

The optical waveguide 101 is the optical waveguide of the embodiment described above. The optical waveguide 101 may be the optical waveguide 1 illustrated in FIGS. 1 and 3 and the like, or may be the optical waveguides (10a, 10b, 10c, 10d) illustrated in FIGS. 4, 5, 6A, and 6B. FIG. 7 illustrates, as an example, the optical waveguide 1 of FIG. 1. Therefore, the optical waveguide 101 in FIG. 7 includes the laminated lower cladding 21, cores 3, and upper cladding 22, and has the upper cladding non-formation region (1a) and the upper cladding formation region (1b). Each core 3 has, at one end, the core exposed portion (3a) exposed in the upper cladding non-formation region (1a). The width of the core exposed portion (3a) is greater than the width of the core non-exposed portion (3b).

The component (E1) is mounted on the wiring board 100. The component (E1) is an optical component, such as a semiconductor device including a photoelectric conversion element or the like, as described in the description of the optical waveguide 1 in FIG. 1 and the like. The component (E1) includes the light-receiving or light-emitting part (E1a) and ball-shaped electrodes (E1b). Examples of the component (E1) include: light receiving elements such as a photodiode; and light emitting elements such as a light emitting diode (LED), an organic light emitting diode (OLED), a laser diode (LD), and a vertical cavity surface emitting laser (VCSEL). When the component (E1) is a light-emitting element, the component (E1) generates an optical signal based on an electrical signal input to the electrodes (E1b) and emits the optical signal from the light-receiving or light-emitting part (E1a), which functions as a light-emitting part, toward the cores 3. When the component (E1) is a light-receiving element, an electrical signal is generated based on an optical signal entering from the light-receiving or light-emitting part (E1a), which functions as a light-receiving part, and is output from the electrodes (E1b).

The component (E1) is mounted on the wiring board 100 by connecting the electrodes (E1b) to the component mounting pads 4, for example, using solder or the like. In FIG. 7, the component (E1) is flip-chip mounted. The light-receiving or light-emitting part (E1a) and the core exposed portions (3a) of the cores 3 in the optical waveguide 101 are positioned to face each other to be optically coupled. Since the optical waveguide 101 is the optical waveguide of the embodiment, such as the optical waveguide 1 illustrated in FIG. 1, alignment between the core exposed portions (3a) and the light-receiving or light-emitting part (E1a) of the component (E1) is facilitated, and thus it is thought that optical coupling (particularly adiabatic coupling) with excellent coupling efficiency is possible. In addition, an optical signal from the component (E1) or to the component (E1) may be transmitted in the optical waveguide 101 in a desired transmission mode, such as a single mode. That is, according to the wiring board 100 of the present embodiment, high-efficiency, low-loss, and high-speed optical transmission can be provided to an optical component optically coupled to the optical waveguide 101.

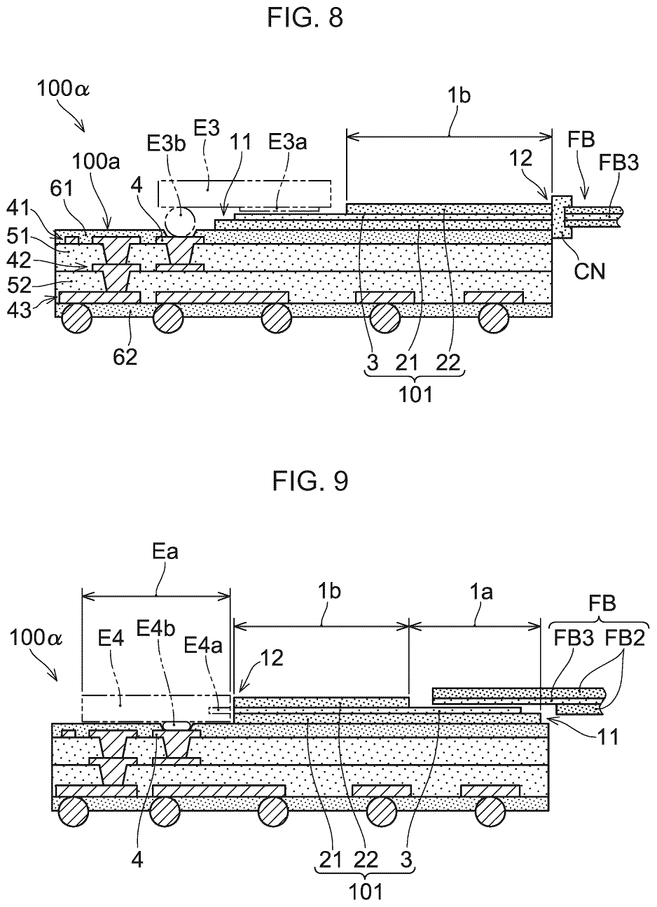

FIG. 8 illustrates a wiring board (100α), which is an application example of the wiring board 100 illustrated in FIG. 7. The wiring board (100α) includes an optical waveguide 101 similarly to the wiring board 100 of FIG. 7. The optical waveguide 101 illustrated in FIG. 8 may be the optical waveguide 1 illustrated in FIG. 1 and the like, or may be the optical waveguide (10a) illustrated in FIG. 4. The optical waveguide 101 is formed on a first surface (100a) of the wiring board (100α). On the first surface (100a) side of the wiring board (100α), a component (E3) is mounted when the wiring board (100α) is in use.

The component (E3) is an optical component, such as a semiconductor device including a photoelectric conversion element or the like, similar to the component (E1) illustrated in FIG. 7. The component (E3) includes a light-receiving or light-emitting part (E3a) that functions similarly to the light-receiving or light-emitting part (E1a) of the component (E1), and ball-shaped electrodes (E3b) that function similarly to the electrodes (E1b) of the component (E1) illustrated in FIG. 7. The light-receiving or light-emitting part (E3a) of the component (E3) is optically coupled to the cores 3 at the one end 11 of the optical waveguide 101. The electrodes (E3b) are connected to the component mounting pads 4 of the wiring board (100α).

The wiring board (100α) has the same structure as the wiring board 100, except that the number of the component mounting pads 4 connected to the electrodes (E3b) of the component (E3) differs from the number of the component mounting pads 4 in the wiring board 100 of FIG. 7. In the wiring board (100α), a structural element that is the same as a structural element of the wiring board 100 illustrated in FIG. 7 is denoted in FIG. 8 using the same reference numeral symbol as the one used in FIG. 7 or is omitted as appropriate, and a repetitive description of the same structural element is omitted.

In the wiring board (100α) of FIG. 8, when the wiring board (100α) is in use, each core 3 in the upper cladding formation region (1b) is optically coupled, at the other end 12 of the optical waveguide 101, to an optical fiber (FB), which is an external optical connection component. In the example of FIG. 8, the optical fiber (FB) and the optical waveguide 101 are optically coupled via an optical connector (CN). An optical signal that has propagated through a core (FB3) of the optical fiber (FB) can enter a core 3 of the optical waveguide 101 from the other end 12 via the optical connector (CN). Further, an optical signal that has propagated from the one end 11 to the other end 12 in a core 3 can enter the core (FB3) of the optical fiber (FB) via the optical connector (CN). The wiring board 100 and the wiring board (100α) can also be applied without being limited in material or structure as long as they are wiring boards. The waveguide of the wiring board (100a) of FIG. 8 has a core exposed portion on the one end side and no core exposed portion on the other end side.

### First Modified Example

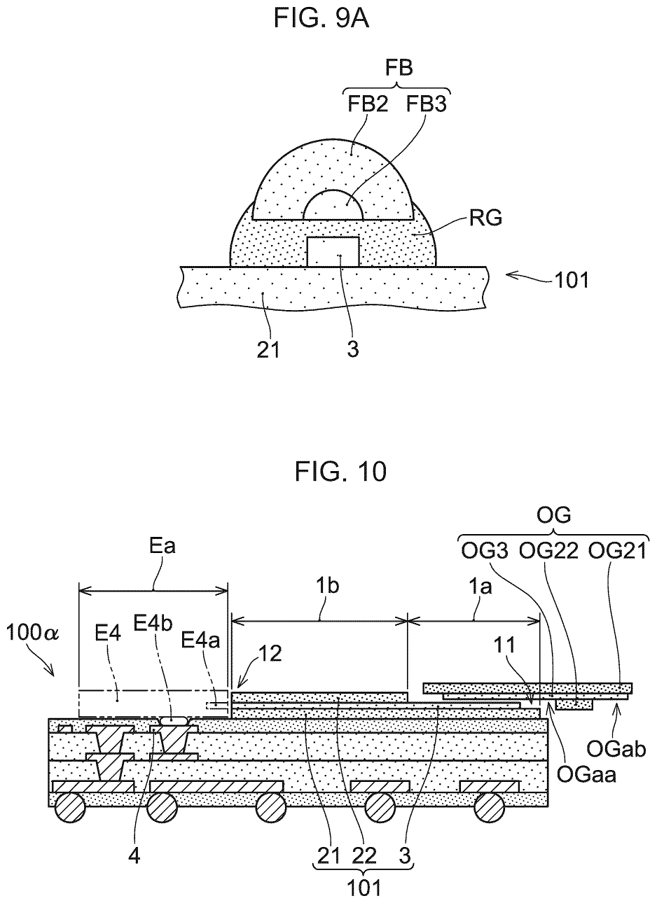

FIG. 9 illustrates a first modified example of the wiring board (100α) of the first embodiment illustrated in FIG. 8. The wiring board (100α) illustrated in FIG. 9 includes an optical waveguide 101 similarly to the wiring board (100α) of FIG. 8. FIG. 9A illustrates a cross section of a coupling portion between the optical fiber (FB) and the optical waveguide 101 in FIG. 9. The optical waveguide 101 illustrated in FIG. 9 may be the optical waveguide 1 illustrated in FIG. 1 and the like, or may be the optical waveguide (10a) illustrated in FIG. 4. The structure of the wiring board (100α) in the example of FIG. 9 is the same as that of the wiring board (100α) of FIG. 8, except for the orientation of the formation of the optical waveguide 101. In the wiring board (100α) of FIG. 9, a structural element that is the same as a structural element of the wiring board (100α) illustrated in FIG. 8 is denoted in FIG. 9 using the same reference numeral symbol as the one used in FIG. 8 or is omitted as appropriate, and a repetitive description of the same structural element is omitted.

In the example of FIG. 9, when the wiring board (100α) is in use, a component (E4) is positioned on the wiring board (100α). The component (E4) is an optical component such as a semiconductor device including a photoelectric conversion element or the like. The component (E4) includes a light-receiving or light-emitting part (E4a), which is a portion where an optical signal enters the component (E4) or a portion from which an optical signal exits the component (E4), as well as electrodes (E4b) through which an electrical signal is input or output. The light-receiving or light-emitting part (E4a) is exposed on a side surface of the component (E4). The electrodes (E4b) are connected to the component mounting pads 4 of the wiring board (100α).

The optical waveguide 101 is formed such that each core 3 in the upper cladding formation region (1b) of the optical waveguide 101 is optically coupled by end-face connection to the light-receiving or light-emitting part (E4a) of the component (E4) at the other end 12 of the optical waveguide 101. That is, the optical waveguide 101 in FIG. 9 is formed on the wiring board (100α) such that an end surface of each core 3 exposed at an end surface of the optical waveguide 101 on the other end 12 side faces the light-receiving or light-emitting part (E4a) exposed on the side surface of the component (E4).

On the other hand, in the example of FIG. 9, each core 3 exposed in the upper cladding non-formation region (1a) including the one end 11 of the optical waveguide 101 is optically coupled to a core of an external optical connection component. In the example of FIG. 9, each core 3 in the upper cladding non-formation region (1a) of the optical waveguide 101 is optically coupled to a core (FB3) of an optical fiber (FB). That is, in the example of FIG. 9, the one end 11 of the optical waveguide 101 is positioned near an edge of the wiring board (100α) that is optically coupled to an external optical connection component. On the other hand, the other end 12 of the optical waveguide 101 is positioned to face a component mounting region (Ea) where the component (E4) is positioned on the wiring board (100g). By forming the optical waveguide 101 in this manner, an optical signal can be propagated between the optical fiber (FB) and the component (E4) via the optical waveguide 101.

In a portion of the optical fiber (FB) of FIG. 9 that is optically coupled to the optical waveguide 101, as illustrated in FIGS. 9 and 9A, the core (FB3) is exposed over a predetermined length. FIG. 9A illustrates an enlarged cross section of the coupling portion between the optical fiber (FB) and the optical waveguide 101, and the cross section illustrated in FIG. 9A is perpendicular to a direction in which the core 3 extends. As illustrated in FIG. 9A, the core (FB3) and a cladding (FB2) in half of the circular cross section of the optical fiber (FB) are removed over a predetermined length along the direction in which the core (FB3) extends. As a result, the core (FB3) is exposed over a predetermined length with a width substantially equal to the diameter of the core (FB3), and the exposed core (FB3) and the core 3 exposed in the upper cladding non-formation region (1a) of the optical waveguide 101 face each other. Therefore, the optical fiber (FB) and the optical waveguide 101 can be optically coupled (adiabatically coupled) with good efficiency.

In FIG. 9A, an optical resin (RG) is filled between the optical fiber (FB) and the optical waveguide 101. The optical resin (RG) may, for example, adjust a refractive index between the core 3 and the core (FB3) or prevent intrusion of foreign matter from entering the coupling portion between the core 3 and the core (FB3). Further, the optical fiber (FB) and the optical waveguide 101 may be bonded by the optical resin (RG). The waveguide of the wiring board (100α) of FIG. 9 has a core exposed portion on the one end side and no core exposed portion on the other end side.

### Second Modified Example

FIG. 10 illustrates a second modified example of the wiring board (100α) of the first embodiment illustrated in FIG. 8. The wiring board (100α) illustrated in FIG. 10 includes an optical waveguide 101 similarly to the wiring board (100α) of FIG. 8. The optical waveguide 101 illustrated in FIG. 10 may be the optical waveguide 1 illustrated in FIG. 1 and the like, or may be the optical waveguide (10a) illustrated in FIG. 4. The structure of the wiring board (100α) in the example of FIG. 10 is the same as that of the wiring board (100g) of FIG. 8, except for the orientation of the formation of the optical waveguide 101. In the wiring board (100α) of FIG. 10, a structural element that is the same as a structural element of the wiring board (100α) illustrated in FIG. 8 is denoted in FIG. 10 using the same reference numeral symbol as the one used in FIG. 8 or is omitted as appropriate, and a repetitive description of the same structural element is omitted.

In the example of FIG. 10, when the wiring board (100α) is in use, a component (E4) is positioned on the wiring board (100α). The component (E4) is an optical component such as a semiconductor device including a photoelectric conversion element or the like. The component (E4) includes a light-receiving or light-emitting part (E4a), which is a portion where an optical signal enters the component (E4) or a portion from which an optical signal exits the component (E1), as well as electrodes (E4b) through which an electrical signal is input or output. The light-receiving or light-emitting part (E4a) is exposed on a side surface of the component (E4). The electrodes (E4b) are connected to the component mounting pads 4 of the wiring board (100α).

The optical waveguide 101 is formed such that each core 3 in the upper cladding formation region (1b) of the optical waveguide 101 is optically coupled by end-face connection to the light-receiving or light-emitting part (E4a) of the component (E4) at the other end 12 of the optical waveguide 101. That is, the optical waveguide 101 in FIG. 10 is formed on the wiring board (100α) such that an end surface of each core 3 exposed at an end surface of the optical waveguide 101 on the other end 12 side faces the light-receiving or light-emitting part (E4a) exposed on the side surface of the component (E4).

On the other hand, in the example of FIG. 10, each core 3 exposed in the upper cladding non-formation region (1a) including the one end 11 of the optical waveguide 101 is optically coupled to a core of an external optical connection component. In FIG. 10, each core 3 in the upper cladding non-formation region (1a) of the optical waveguide 101 is optically coupled to a core (OG3) of an external optical waveguide (OG). That is, in the example of FIG. 10, the one end 11 of the optical waveguide 101 is positioned near an edge of the wiring board (100α) that is optically coupled to an external optical connection component. On the other hand, the other end 12 of the optical waveguide 101 is positioned to face a component mounting region (Ea) where the component (E4) is positioned on the wiring board (100α). By forming the optical waveguide 101 in this manner, an optical signal can be propagated between the external optical waveguide (OG) and the component (E4) via the optical waveguide 101.

In the example of FIG. 10, the external optical waveguide (OG) that is optically coupled to the optical waveguide 101 includes a lower cladding (OG21), cores (OG3), and an upper cladding (OG22). The external optical waveguide (OG) includes an upper cladding non-formation region (OGaa) and an upper cladding non-formation region (OGab), which are regions where the upper cladding (OG22) is not formed. The cores (OG3) exposed in the upper cladding non-formation region (OGaa) is optically coupled (adiabatically coupled) to the cores 3 exposed in the upper cladding non-formation region (1a) of the optical waveguide 101. The waveguide of the wiring board (100α) of FIG. 10 has a core exposed portion on the one end side and no core exposed portion on the other end side.

### Structure of Wiring Board

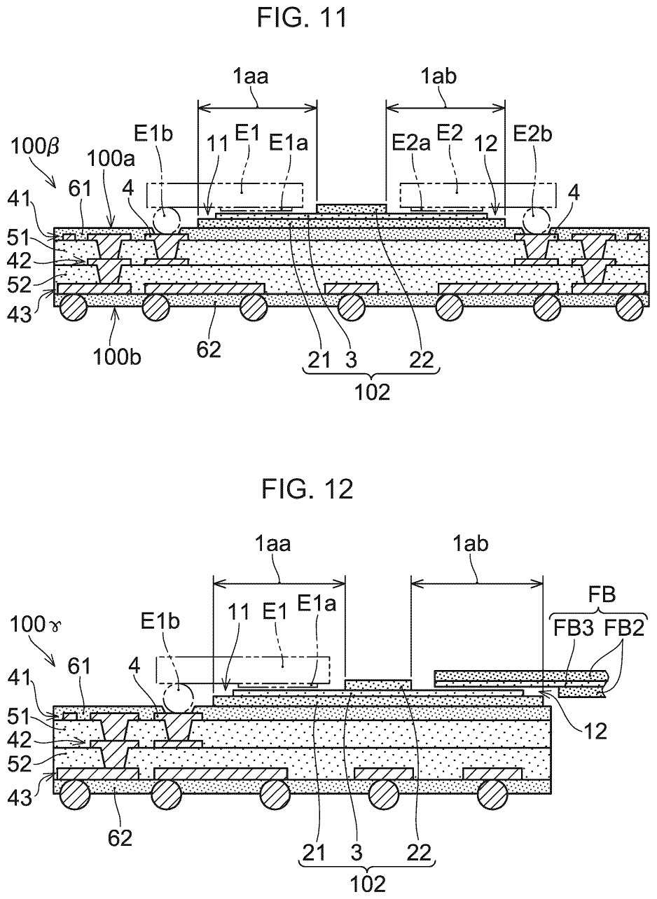

FIG. 11 illustrates a wiring board (100β), which is an example of a wiring board according to a second embodiment. The wiring board (100β) includes an optical waveguide 102 formed on the first surface (100a) of the wiring board (100β). The optical waveguide 102 is the optical waveguide of the embodiment described above and may be the optical waveguide (10b) illustrated in FIG. 5. That is, the optical waveguide 102 has a first upper cladding non-formation region (1aa) on the one end 11 side and a second upper cladding non-formation region (1ab) on the other end 12 side. The wiring board of the second embodiment, such as the wiring board (100β), includes an optical waveguide having upper cladding non-formation regions at both the one end 11 and the other end 12.

The wiring board (100β) of FIG. 11 has the same layer structure as the wiring board 100 and wiring board (100α) illustrated in FIGS. 7 to 10. That is, in the wiring board (100β), conductor layers and insulating layers are formed in the order of a conductor layer 43, an insulating layer 52, a conductor layer 42, an insulating layer 51, and a conductor layer 41 from the second surface (100b) side toward the first surface (100a) side of the wiring board (100β). Further, a solder resist 62 covering the conductor layer 43 and the insulating layer 52, and a solder resist 61 covering the conductor layer 41 and the insulating layer 51 are formed. In the wiring board (100β) of FIG. 11, a structural element that is the same as a structural element of the wiring board 100 or wiring board (100α) illustrated in FIGS. 7 to 10 is denoted using the same reference numeral symbol as the one used in FIGS. 7 to 10 or is omitted as appropriate, and a repetitive description is omitted.

On the other hand, the wiring board (100β) of FIG. 11 differs from the wiring board 100 and the wiring board 100 (100α) illustrated in FIGS. 7 to 10 in that the component mounting pads 4 are provided on both the one end 11 side and the other end 12 side of the optical waveguide 102. That is, when the wiring board (100β) is in use, a component (E1) is positioned on the one end 11 side of the optical waveguide 102, and a component (E2) is positioned on the other end 12 side. The component (E1) illustrated in FIG. 11 may be the component (E1) illustrated in FIG. 1 and the like, and the component (E2) illustrated in FIG. 11 may be the component (E2) illustrated in FIG. 5. That is, both the component (E1) and the component (E2) in FIG. 11 may be photoelectric conversion components such as semiconductor devices including photoelectric conversion elements, and the component (E1) and the component (E2) may be the same type of photoelectric conversion components. The component (E1) includes a light-receiving or light-emitting part (E1a) and electrodes (E1b), and the component (E2) includes a light-receiving or light-emitting part (E2a) and electrodes (E2b). The electrodes (E1b) of the component (E1) are connected to the component mounting pads 4 on the one end 11 side of the optical waveguide 102, and the electrodes (E2b) of the component (E2) are connected to the component mounting pads 4 on the other end 12 side of the optical waveguide 102.

The component (E1) is positioned on the wiring board (100β) such that the light-receiving or light-emitting part (E1a) faces the cores 3 exposed in the first upper cladding non-formation region (1aa) of the optical waveguide 102. The component (E2) is positioned on the wiring board (100β) such that the light-receiving or light-emitting part (E2a) faces the cores 3 exposed in the second upper cladding non-formation region (1ab) of the optical waveguide 102. As a result, the cores 3 exposed in the first upper cladding non-formation region (1aa) of the optical waveguide 102 are optically coupled (adiabatically coupled) to the light-receiving or light-emitting part (E1a) of the component (E1). Further, the cores 3 exposed in the second upper cladding non-formation region (1ab) are optically coupled (adiabatically coupled) to the light-receiving or light-emitting part (E2a) of the component (E2). By forming the optical waveguide 102, the component (E1), and the component (E2) in this manner, it is thought that an electrical signal can be transmitted at high speed between the one end 11 side and the other end 12 side of the optical waveguide 102, while suppressing influence of electromagnetic noise, by converting the electrical signal temporarily into an optical signal. The waveguide of the wiring board (100β) of FIG. 11 has a core exposed portion on the one end side and another core exposed portion on the other end side. In other words, the waveguide of the wiring board (100β) of FIG. 11 has two core exposed portions, and thus, may take a form not only as illustrated in FIG. 5 but also as illustrated in FIG. 6A or 6B.

### First Modified Example

FIG. 12 illustrates a wiring board (100γ), which is a first modified example of the wiring board of the second embodiment. The wiring board (100γ) has the same structure as the wiring board (100α) illustrated in FIGS. 8 to 10 with respect to the conductor layers (41-43), the insulating layers (51, 52), and the solder resists (61, 62). On the other hand, the wiring board (100γ) includes an optical waveguide 102 that is different from the optical waveguide 101 included in the wiring board (100α). The optical waveguide 102 included in the wiring board (100γ) may be the optical waveguide (10b) illustrated in FIG. 5, similarly to the optical waveguide 102 included in the wiring board (100β) of FIG. 11.

Also in the wiring board (100γ) of FIG. 12, when the wiring board (100γ) is in use, a component (E1) is positioned on the one end 11 side of the optical waveguide 102, similar to the wiring board (100β) of FIG. 11. In the example of FIG. 12, the component (E1) may be the same as the component (E1) illustrated in FIG. 11, and includes a light-receiving or light-emitting part (E1a) and electrodes (E1b). The optical waveguide 102 and the component (E1) are positioned such that the cores 3 exposed in the first upper cladding non-formation region (1aa) of the optical waveguide 102 face and are optically coupled (adiabatically coupled) to the light-receiving or light-emitting part (E1a) of the component (E1). The electrodes (E1b) of the component (E1) are connected to the component mounting pads 4 included in the wiring board (100γ).

On the other hand, in FIG. 12, the cores 3 exposed in the second upper cladding non-formation region (1ab) on the other end 12 side of the optical waveguide 102 are optically coupled, when the wiring board (100γ) is in use, to cores of an external optical connection component. That is, in the example of FIG. 12, each core 3 exposed in the second upper cladding non-formation region (1ab) of the optical waveguide 102 is optically coupled to a core (FB3) of an optical fiber (FB). In the optical fiber (FB) illustrated in FIG. 12, similarly to the optical fiber (FB) illustrated in FIGS. 9 and 9A, in a portion optically coupled to the optical waveguide 102, the core (FB3) and the cladding (FB2) are partially removed over a predetermined length along the direction in which the core (FB3) extends. As a result, the core (FB3) is exposed over a predetermined length along the direction in which the core (FB3) extends, and the exposed core (FB3) faces and is optically coupled (adiabatically coupled) to the core 3 exposed in the second upper cladding non-formation region (1ab). The waveguide of the wiring board (100γ) of FIG. 12 has a core exposed portion on the one end side and another core exposed portion on the other end side. In other words, the waveguide of the wiring board (100γ) of FIG. 12 has two core exposed portions, and thus, may take a form not only as illustrated in FIG. 5 but also as illustrated in FIG. 6A or 6B.

### Second Modified Example

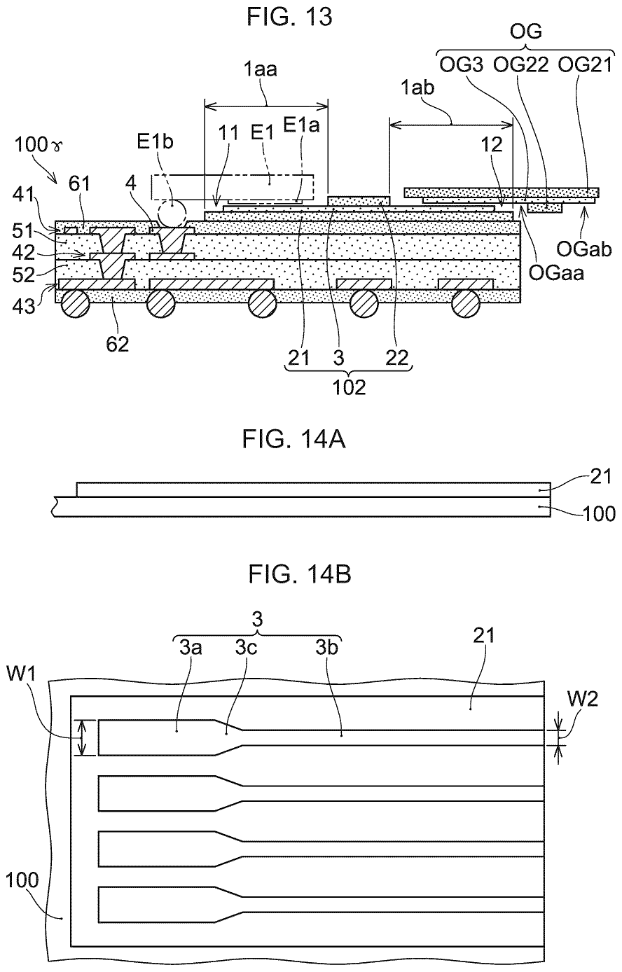

FIG. 13 illustrates a wiring board (100γ), which is a second modified example of the wiring board of the second embodiment. The wiring board (100γ) has the same structure as the wiring board (100g) illustrated in FIGS. 8 to 10 with respect to the conductor layers (41-43), the insulating layers (51, 52), and the solder resists (61, 62). On the other hand, the wiring board (100γ) includes an optical waveguide 102 that is different from the optical waveguide 101 included in the wiring board (100α). The optical waveguide 102 included in the wiring board (100γ) may be the optical waveguide (10b) illustrated in FIG. 5, similarly to the optical waveguide 102 included in the wiring board (100β) of FIG. 11.

Also in the wiring board (100γ) of FIG. 13, when the wiring board (100γ) is in use, a component (E1) is positioned on the one end 11 side of the optical waveguide 102, similar to the wiring board (100β) of FIG. 11. In the example of FIG. 13, the component (E1) may be the same as the component (E1) illustrated in FIG. 11, and includes a light-receiving or light-emitting part (E1a) and electrodes (E1b). The optical waveguide 102 and the component (E1) are positioned such that the cores 3 exposed in the first upper cladding non-formation region (1aa) of the optical waveguide 102 face and are optically coupled (adiabatically coupled) to the light-receiving or light-emitting part (E1a) of the component (E1). The electrodes (E1b) of the component (E1) are connected to the component mounting pads 4 included in the wiring board (100γ).

On the other hand, in FIG. 13, the cores 3 exposed in the second upper cladding non-formation region (1ab) on the other end 12 side of the optical waveguide 102 are optically coupled, when the wiring board (100γ) is in use, to cores of an external optical connection component. That is, in the example of FIG. 13, each core 3 exposed in the second upper cladding non-formation region (1ab) of the optical waveguide 102 is optically coupled to a core (OG3) of an external optical waveguide (OG). The external optical waveguide (OG) illustrated in FIG. 13 has the same structure as the external optical waveguide (OG) illustrated in FIG. 10. That is, the external optical waveguide (OG) illustrated in FIG. 13 includes a lower cladding (OG21), cores (OG3), and an upper cladding (OG22), and has an upper cladding non-formation region (OGaa) and an upper cladding non-formation region (OGab). The cores (OG3) exposed in the upper cladding non-formation region (OGaa) are optically coupled by adiabatic coupling to the cores 3 exposed in the second upper cladding non-formation region (1ab) of the optical waveguide 102. The waveguide of the wiring board (100γ) of FIG. 13 has a core exposed portion on the one end side and another core exposed portion on the other end side. In other words, the waveguide of the wiring board (100γ) of FIG. 13 has two core exposed portions, and thus, may take a form not only as illustrated in FIG. 5 but also as illustrated in FIG. 6A or 6B.

The form of connection between the optical waveguide of the embodiment or the optical waveguide provided in the wiring board of the embodiment and an external optical component is not limited to the forms illustrated in FIGS. 8 to 13. The optical waveguide of the embodiment and the optical waveguide provided in the wiring board of the embodiment may be optically coupled to an external optical component in any form.

### Method for Manufacturing Optical Waveguide

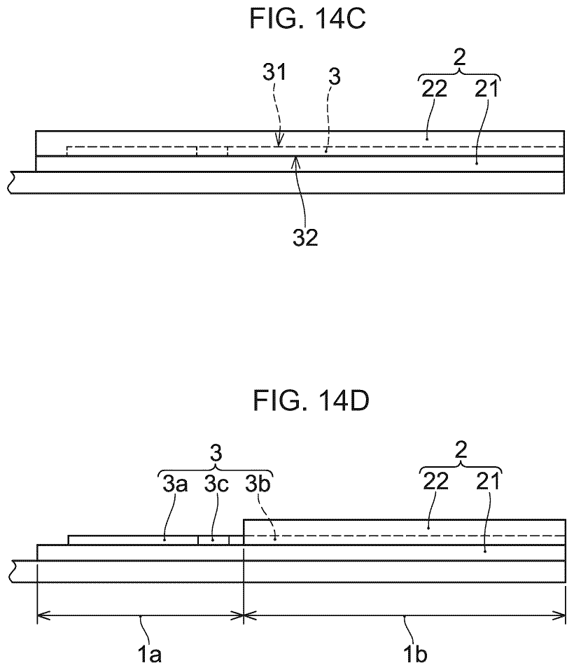

A method for manufacturing the optical waveguide of the embodiment is described with reference to FIGS. 14A to 14D. In the following, as an example, a method in which an optical waveguide is directly formed on a wiring board (for example, the wiring board 100 of FIG. 7) is described. As illustrated in FIG. 14A, a wiring board 100 is prepared, and a lower cladding 21 is formed on a surface of a solder resist (not illustrated) of the wiring board 100. The lower cladding 21 is formed, for example, by thermocompression bonding a film-shaped constituent material of the lower cladding 21 to the wiring board 100 or by applying a resin composition by spin coating to form a film. For example, a constituent material of the lower cladding 21, such as PMMA, is formed into a film shape and thermocompression bonded to the wiring board 100. The optical waveguide may be formed on a surface of the wiring board 100 on which no solder resist is formed.

As illustrated in FIG. 14B, cores 3 each having a desired shape in plan view are formed. The cores 3 are formed using any formation method. As an example, the cores 3 are formed using photolithography. That is, a layer made of a photosensitive constituent material of the cores 3, such as PMMA, is formed over the entire surface of the lower cladding 21. As an example, the constituent material of the cores 3 is applied by spin coating to form a film made of the constituent material of the cores 3. Further, the constituent material of the cores 3 may be formed into a film shape and thermocompression bonded to the surface of the lower cladding 21. A constituent material of the cores 3 having a higher refractive index than the lower cladding 21 may be applied, or a film-shaped material having a higher refractive index than the lower cladding 21 may be thermocompression bonded. Then, by performing exposure and development through a mask corresponding to the shape of the cores 3 to be formed, the layer made of the constituent material of the cores 3 on the lower cladding 21 is patterned, and a desired number of cores 3 having a desired shape are formed.

Each core 3 is formed to have a portion corresponding to the core non-exposed portion (3b) having the width (W2), a portion corresponding to the core exposed portion (3a) having the width (W1) greater than the width (W2), and a portion corresponding to the connecting portion (3c) that connects the core non-exposed portion (3b) and the core exposed portion (3a). In the example of FIG. 14B, the portion corresponding to the connecting portion (3c) is formed in a shape that is a combination of a tapered shape and a constant-width shape. The core exposed portion (3a) is formed so as to be located in an upper cladding non-formation region (1a) (see FIG. 14D) to be provided in a subsequent process, and the core non-exposed portion (3b) is formed so as to be located in an upper cladding formation region (1b) (see FIG. 14D) to be provided in a subsequent process. The connecting portion (3c) is formed so as to connect the core exposed portion (3a) and the core non-exposed portion (3b) in the upper cladding non-formation region (1a). The connecting portion (3c) is not limited to having a shape that is a combination of a tapered shape and a constant-width shape, but may also have a tapered shape alone or a constant-width shape alone.

Examples of methods for forming the cores 3 having a desired shape include, in addition to the method using photolithography, a photobleaching method and a core cutting method. In the photobleaching method, ultraviolet light or the like is irradiated onto non-masked regions of a layer that is formed over the entire surface of the lower cladding 21 and has a higher refractive index than the lower cladding 21, using a mask that shields regions where the cores 3 are to be formed. By lowering the refractive index of the irradiated regions, the cores 3 are formed. In the core cutting method, the cores 3 having a desired shape are formed by cutting a layer that is formed over the entire surface of the lower cladding 21 and has a higher refractive index than the lower cladding 21 into a desired shape using laser light or the like. The cores 3 may also be formed using such a photobleaching method or core cutting method.

As illustrated in FIG. 14C, an upper cladding 22 is formed on the cores 3 and the lower cladding 21. For example, similarly to the formation of the lower cladding 21, a constituent material of the upper cladding 22, such as PMMA, is applied by spin coating onto the lower cladding 21 and the cores 3 to form a film made of the constituent material of the upper cladding 22. Further, a constituent material of the upper cladding 22, such as PMMA, may be formed into a film shape and thermocompression bonded. When the upper cladding 22 is integrated with or at least adhered to the lower cladding 21, a cladding 2 surrounding the cores 3 is formed. At the stage illustrated in FIG. 14C, the upper cladding 22 is in contact with an upper surface 31 and side surfaces of each core 3, and the upper cladding 22 is formed so as to surround each core 3, while the lower cladding 21 is formed on a lower surface 32 of each core 3. Thus, the cladding 2 is formed so as to surround the cores 3. The cladding 2 may also be formed to surround the cores 3 by forming the upper cladding 22 on the upper surface 31 of each core 3 and forming the lower cladding 21 in contact with the side surfaces and lower surface 32 of each core 3.

As illustrated in FIG. 14D, a portion of the upper cladding 22 that covers the core exposed portion (3a) and the connecting portion (3c) of each core 3 is removed. For example, a portion of the upper cladding 22 on the core exposed portion (3a) side is removed over an entire length in the direction of the width (W1) of the core exposed portion (3a) (see FIG. 14B). As a result, the core exposed portion (3a) of each core 3 is exposed from the cladding 2. That is, by removing a part of the upper cladding 22, an upper cladding non-formation region (1a) and an upper cladding formation region (1b) are provided. The core non-exposed portion (3b) remains covered by the upper cladding 22 in the upper cladding formation region (1b).

The portion of the upper cladding 22 to be removed is removed, for example, using photolithography. The portion of the upper cladding 22 to be removed may also be removed by laser processing, and the removal method is not limited to these methods. Further, a film that is the constituent material of the upper cladding 22 may be thermocompression bonded so that the core exposed portion (3a) is not covered.

Instead of the wiring board 100, a support plate (not illustrated) may be prepared, and the optical waveguide may be formed on the support plate. The optical waveguide during manufacturing is supported, and appropriate rigidity is imparted to the optical waveguide during manufacturing. A support plate having substantially the same size and substantially the same shape in plan view as the optical waveguide to be manufactured may be prepared, or a support plate that is slightly larger in plan view than the optical waveguide to be manufactured may be prepared. The support plate may have an adhesive layer (not illustrated) on a surface on which the lower cladding 21 is to be formed. In this case, after completion of the optical waveguide, the support plate may be peeled off from the completed optical waveguide at the adhesive layer. The optical waveguide to be manufactured may be used with the support plate attached after completion.

The support plate is preferably formed of a material having higher rigidity than the optical waveguide to be manufactured. The support plate may be formed of a material having a lower thermal expansion coefficient than that of the optical waveguide to be manufactured. Displacement of the optical waveguide due to temperature changes may be suppressed. Examples of materials for the support plate include: glasses such as soda-lime glass, borosilicate glass, and quartz glass; various metals such as tungsten, titanium, and molybdenum; and various ceramics such as alumina, silicon nitride, and silicon oxide; and the like.

The support plate may have moderate flexibility, and, for example, a support plate made of a resin film may be prepared. When the optical waveguide is used with the support plate attached, the degree of freedom in the shape of the optical waveguide during use may be increased.

When the optical waveguide to be manufactured is to be used without the support plate, the support plate is removed after defining the upper cladding non-formation region (1a) as illustrated in FIG. 14D. By removing the support plate, a standalone optical waveguide is completed. The support plate may be removed using any method. For example, when the support plate and the lower cladding 21 are bonded with an adhesive layer (not illustrated) made of a thermoplastic adhesive, the optical waveguide with the support plate is heated to reduce adhesiveness of the adhesive, and then the support plate is peeled off from the lower cladding 21. Further, when the lower cladding 21 is bonded to a light-transmissive support plate with an adhesive layer (not illustrated) made of a photoplastic adhesive, light may be irradiated from the support plate side toward the lower cladding 21 to reduce adhesiveness of the adhesive, and then the support plate may be peeled off from the lower cladding 21. The optical waveguide after the support plate has been removed is formed, for example, on a wiring board 100 as described with reference to FIG. 7.

### Method for Manufacturing Wiring Board

The wiring board 100 of the embodiment described with reference to FIG. 7 may be manufactured by sequentially forming the conductor layer 43, the insulating layer 52, the conductor layer 42, the insulating layer 51, and the conductor layer 41, and then forming the optical waveguide 101 on this laminate using the manufacturing method described with reference to FIGS. 14A to 14D. The optical waveguide 101 may be separately manufactured on a support plate (not illustrated) that supports the optical waveguide 101 during manufacturing, and then, after removing the support plate or with the support plate attached, may be formed on the wiring board 100 before optical waveguide placement.

The conductor layer 43 is formed, for example, on a supporting substrate (not illustrated) such as a double-sided copper-clad laminate using a method such as a semi-additive method. After the formation of the conductor layer 43, the insulating layer 52 covering the conductor layer 43 is formed, for example, by laminating and thermocompression bonding a film-shaped insulating resin such as epoxy resin. Through holes are formed in the insulating layer 52, for example, by irradiation with CO₂ laser light. After the formation of the through holes, the conductor layer 42 is formed on the insulating layer 52 and via conductors 7 are formed in the through holes of the insulating layer 52, for example, using a semi-additive method. Further, the insulating layer 51 is formed on the conductor layer 42 and the insulating layer 52 using the same method as that used for the insulating layer 52. The conductor layer 41 is formed on the insulating layer 51 using the same method as that used for the conductor layer 42, and via conductors 7 are formed in the insulating layer 51 using the same method as that used for the via conductors 7 in the insulating layer 52. After removing the supporting substrate by peeling or the like, the solder resists (61, 62) are formed by application or spraying of a photosensitive epoxy resin. In the solder resists (61, 62), openings, such as the openings (61a), that expose portions of the conductor layer 41 or portions of the conductor layer 43 are formed by exposure and development.

Then, the optical waveguide 101 is manufactured using the method described with reference to FIGS. 14A to 14D on a surface on the conductor layer 41 side of the laminate including the conductor layers (41 to 43) and the insulating layers (51, 52). Alternatively, the optical waveguide 101 may be separately manufactured on any support plate (not illustrated) and then formed. For example, any adhesive (not illustrated), such as a thermosetting, room-temperature curing, or photocurable adhesive, is supplied onto the surface of the solder resist 61, and the optical waveguide 101 is mounted thereon. When necessary, a curing treatment of the adhesive by heating or the like is performed, and the optical waveguide 101 is fixed onto the laminate including the conductor layers and the insulating layers. After manufacturing or forming the optical waveguide 101, the bumps 8 are formed by mounting conductive balls made of solder or the like and performing a reflow process or the like. Through the above processes, the wiring board 100 in the example of FIG. 7 is completed.

Unlike the example of FIG. 7, it is also possible that the optical waveguide 101 is manufactured, or formed, not on the solder resist 61, but on a region of the surface of the insulating layer 51 where the solder resist 61 and the conductor layer 41 are not provided. Further, it is also possible that the optical waveguide 101 is formed on the surface of the laminate including the conductor layers and the insulating layers while still including the support plate (not illustrated) used during manufacturing of the optical waveguide 101.

The wiring boards (100α-100γ) illustrated in FIGS. 8 to 13 can also be manufactured using methods similarly to the method for manufacturing the wiring board 100 described above. That is, the wiring boards (100α-100γ) can be manufactured by sequentially forming the conductor layers, the insulating layers, and the solder resists, and then forming the optical waveguide 101 or the optical waveguide 102 on the surface of the solder resist 61 or the insulating layer 51 using the method described with reference to FIGS. 14A to 14D. Alternatively, the optical waveguide 101 or the optical waveguide 102 may be formed on a support plate and then formed on the surface of the separately formed solder resist layer 61 or insulating layer 51.

The optical waveguide and the wiring board of the embodiment are not limited to those having the structures illustrated in the drawings and those having the structures, shapes, and materials exemplified in the present specification. The wiring board of the embodiment may have any laminated structure and may include any number of conductor layers and insulating layers. For example, the wiring board of the embodiment may be a buildup wiring board including a core substrate, a multilayer wiring board without buildup layers, or a double-sided or single-sided wiring board. The bumps 8 are not necessarily formed, and the via conductors 7 are also not necessarily provided. Further, the thickness of each core of the optical waveguide of the embodiment may vary in each of the core exposed portion and the core non-exposed portion.

Japanese Patent Application Laid-Open Publication No. 2014-81586 describes a polymer waveguide array formed on a polymer film and a silicon waveguide array formed on a silicon chip. A core of a polymer waveguide and a core of a silicon waveguide are formed so as to overlap each other over a predetermined distance in an optical axis direction and are optically coupled by adiabatic coupling.

The structure described in Japanese Patent Application Laid-Open Publication No. 2014-81586 is a coupled body in which a silicon chip on which a silicon waveguide is formed is face-down mounted on and adiabatically coupled to a polymer waveguide. In the polymer waveguide, at an optical coupling location with the silicon waveguide, the width of the core of the polymer waveguide is not sufficiently larger relative to the width of the core of the silicon waveguide, and therefore, the allowable range for alignment between the polymer waveguide and the silicon waveguide is narrow, and thus, it may not be possible to optically couple the polymer waveguide and the silicon waveguide with sufficient coupling efficiency. In the coupled body of the polymer waveguide and the silicon waveguide, it is also thought that, due to thermal history during use, the core of the polymer waveguide and the core of the silicon waveguide may suffer coupling failure due to positional misalignment.

An optical waveguide according to an embodiment of the present invention is an optical waveguide in which a lower cladding, a core, and an upper cladding are laminated in this order, and a portion of the core on a side where an optical signal enters and a portion of the core on a side where an optical signal exits are exposed. The optical waveguide includes an upper cladding non-formation region and an upper cladding formation region. The core has a core exposed portion where an upper surface of the core is exposed at at least one end of the optical waveguide in the upper cladding non-formation region. The core has a core non-exposed portion where the upper surface of the core is not exposed in the upper cladding formation region. A core width (W1) of the core exposed portion and a core width (W2) of the core non-exposed portion satisfy a relationship of the following Formula 1: W1>W2.

A wiring board according to an embodiment of the present invention includes: the above optical waveguide; component mounting pads; insulating layers; and conductor layers. The optical waveguide is formed on a surface of the wiring board.

According to an embodiment of the present invention, the allowable range for alignment between an optical waveguide and an optical component that transmits and receives an optical signal to and from the optical waveguide can be expanded, and therefore, it is thought that the optical waveguide and the optical component can be optically coupled with good coupling efficiency. Further, it is thought that even under thermal history during use, coupling failure due to positional misalignment between the optical waveguide and the optical component can be suppressed.

Obviously, numerous modifications and variations of the present invention are possible in light of the above teachings. It is therefore to be understood that within the scope of the appended claims, the invention may be practiced otherwise than as specifically described herein.

1. An optical waveguide, comprising:
an optical waveguide body comprising a lower cladding, a core and an upper cladding and having an upper cladding non-formation region and an upper cladding formation region,
wherein the optical waveguide body has a core exposed portion and a core non-exposed portion formed such that the core exposed portion has an upper surface of the core exposed at at least one end of the optical waveguide body in the upper cladding non-formation region, the core non-exposed portion has the upper surface of the core not exposed in the upper cladding formation region, and the optical waveguide body is formed to satisfy W1>W2, where W1 is a core width of the core exposed portion and W2 is a core width of the core non-exposed portion.

2. The optical waveguide according to claim 1, wherein the optical waveguide body is formed to satisfy 1.0<(W1/W2)≤3.0.

3. The optical waveguide according to claim 1, wherein the optical waveguide body is formed such that the core width of the core exposed portion, W1, is in a range of 3 μm to 30 μm.

4. The optical waveguide according to claim 1, wherein the optical waveguide body is formed such that the core exposed portion has a core length in a range of 100 μm to 3000 μm.

5. The optical waveguide according to claim 1, wherein the optical waveguide body is formed such that the core has a connecting portion connecting the core exposed portion and the core non-exposed portion.

6. The optical waveguide according to claim 1, wherein the optical waveguide body is formed such that the core has a connecting portion connecting the core exposed portion and the core non-exposed portion and having a tapered shape.

7. The optical waveguide according to claim 5, wherein the optical waveguide body is formed such that the connecting portion is a constant-width straight line.

8. The optical waveguide according to claim 5, wherein the optical waveguide body is formed such that the connecting portion has a constant-width straight line portion and a tapered shape portion.

9. The optical waveguide according to claim 5, wherein the optical waveguide body is formed to satisfy W1>W3≥W2 where W3 is a core width of the connecting portion.

10. The optical waveguide according to claim 1, wherein the optical waveguide body has the core exposed portion at one end of the core and at the other end of the core in the upper cladding non-formation region and is formed to satisfy W11>W21 and W12>W22 where W11 is a core width of the core exposed portion formed at the one end, W12 is a core width of the core exposed portion formed at the other end, W21 is a core width of the core non-exposed portion on a side of the one end, and W22 is a core width of the core non-exposed portion on a side of the other end.

11. The optical waveguide according to claim 10, wherein the optical waveguide body is formed to satisfy 1.0<W11/W21≤3.0 and 1.0<W12/W22≤3.0.

12. The optical waveguide according to claim 10, wherein the core width of the core exposed portion formed at the one end, W11, is in a range of 3 μm to 30 μm, and the core width of the core exposed portion formed at the other end, W12, is in a range of 3 μm to 30 μm.

13. The optical waveguide according to claim 2, wherein the optical waveguide body is formed such that the core width of the core exposed portion, W1, is in a range of 3 μm to 30 μm.

14. The optical waveguide according to claim 2, wherein the optical waveguide body is formed such that the core exposed portion has a core length in a range of 100 μm to 3000 μm.

15. The optical waveguide according to claim 2, wherein the optical waveguide body is formed such that the core has a connecting portion connecting the core exposed portion and the core non-exposed portion.

16. The optical waveguide according to claim 2, wherein the optical waveguide body is formed such that the core has a connecting portion connecting the core exposed portion and the core non-exposed portion and having a tapered shape.

17. The optical waveguide according to claim 15, wherein the optical waveguide body is formed such that the connecting portion is a constant-width straight line.

18. The optical waveguide according to claim 15, wherein the optical waveguide body is formed such that the connecting portion has a constant-width straight line portion and a tapered shape portion.

19. The optical waveguide according to claim 15, wherein the optical waveguide body is formed to satisfy W1>W3≥W2 where W3 is a core width of the connecting portion.

20. A wiring board, comprising:
a wiring board structure comprising a plurality of insulating layers, a plurality of conductor layers, a plurality of component mounting pads, and the optical waveguide of claim 1 formed on a surface of the wiring board body.
